(19) United States
(12) Patent Application Publication
(10) Pub. No.: US 2025/0077984 A1
(43) Pub. Date: Mar. 6, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventors: Shinnosuke NISHIMOTO, Tokyo (JP); Masahiro SERIZAWA, Tokyo (JP); Masahiro IWADARE, Tokyo (JP); Akio YOSHIOKA, Tokyo (JP)

(73) Assignee: NEC Corporation, Tokyo (JP)

(21) Appl. No.: 18/813,165

(22) Filed: Aug. 23, 2024

(30) Foreign Application Priority Data
Sep. 4, 2023 (JP) 2023-143215

(51) Int. Cl. G06N 20/20; G06F 9/451

(52) U.S. Cl. CPC G06N 20/20; G06F 9/451

(57) ABSTRACT

Provided is an information processing apparatus which allows a user to more efficiently obtain useful information from a plurality of services and to more easily carry out optimum selection for the user. An information processing apparatus includes: an input acquisition section for acquiring a first request from a user; an answer acquisition section for acquiring first answers respectively from a first machine learning model and a second machine learning model in response to the first request while causing the second machine learning model to refer to a first answer obtained from the first machine learning model; and a display control section for causing a display apparatus to display a first answer set which includes the first answers obtained respectively from the first machine learning model and the second machine learning model.

This Nonprovisional application claims priority under 35 U.S.C. § 119 on Patent Application No. 2023-143215 filed in Japan on Sep. 4, 2023, the entire contents of which are hereby incorporated by reference.

### TECHNICAL FIELD

The present disclosure relates to a technique to generate an answer in response to a request from a user.

### BACKGROUND ART

A technique to generate an answer in response to a request from a user is known. For example, Patent Literature 1 discloses an automatic response AI that analyzes content of utterance by a user, and provides the user with an answer with respect to the utterance content.

### CITATION LIST

### Patent Literature

### Patent Literature 1

Japanese Patent Application Publication Tokukai No. 2019-49900

### SUMMARY OF INVENTION

### Technical Problem

In recent years, many organizations have provided services to provide, using a technique such as that disclosed in Patent Literature 1, an answer that is appropriate for its own organization in response to a request from a user. However, there is a problem that, in a case where a user wants to compare answers from a plurality of services, it is impossible to more efficiently obtain answers from the respective services.

The present disclosure is accomplished in view of the above problem, and an example object thereof is to provide a technique which allows a user to more efficiently obtain useful information from a plurality of services.

### Solution to Problem

An information processing apparatus in accordance with an example aspect of the present disclosure includes at least one processor, the at least one processor carrying out: an input acquisition process of acquiring a first request from a user; an answer acquisition process of acquiring first answers respectively from a first machine learning model and a second machine learning model in response to the first request while causing the second machine learning model to refer to a first answer obtained from the first machine learning model; and a display control process of causing a display apparatus to display a first answer set which includes the first answers obtained respectively from the first machine learning model and the second machine learning model.

An information processing method in accordance with an example aspect of the present disclosure includes: acquiring, by at least one processor, a first request from a user; acquiring, by the at least one processor, first answers respectively from a first machine learning model and a second machine learning model in response to the first request while causing the second machine learning model to refer to a first answer obtained from the first machine learning model; and causing, by the at least one processor, a display apparatus to display a first answer set which includes the first answers obtained respectively from the first machine learning model and the second machine learning model.

A storage medium in accordance with an example aspect of the present disclosure is a non-transitory storage medium storing a program for causing a computer to function as an information processing apparatus, the program causing the computer to carry out: an input acquisition process of acquiring a first request from a user; an answer acquisition process of acquiring first answers respectively from a first machine learning model and a second machine learning model in response to the first request while causing the second machine learning model to refer to a first answer obtained from the first machine learning model; and a display control process of causing a display apparatus to display a first answer set which includes the first answers obtained respectively from the first machine learning model and the second machine learning model.

### Advantageous Effects of Invention

According to an example aspect of the present disclosure, it is possible to bring about an example advantage of providing a technique which allows a user to more efficiently obtain useful information from a plurality of services.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing system in accordance with the present disclosure.

FIG. 4 is a block diagram illustrating a configuration of a user terminal in accordance with the present disclosure.

FIG. 5 is a block diagram illustrating a configuration of a server in accordance with the present disclosure.

FIG. 6 is a block diagram illustrating a configuration of a management terminal in accordance with the present disclosure.

FIG. 7 is a flowchart for describing a flow of an information processing method in accordance with the present disclosure.

FIG. 8 is a diagram illustrating an example of a screen in a basic function in accordance with the present disclosure.

FIG. 9 is a flowchart for describing a flow of an information processing method in accordance with the present disclosure.

FIG. 10 is a diagram illustrating an example of a screen in an intervention function in accordance with the present disclosure.

FIG. 11 is a diagram illustrating an example of a screen to which a give-up function in accordance with the present disclosure is applied.

FIG. 12 is a flowchart for describing a flow of an information processing method in accordance with the present disclosure.

FIG. 13 is a diagram illustrating a screen example in a flip function in accordance with the present disclosure.

FIG. 14 is a flowchart for describing a flow of an information processing method in accordance with the present disclosure.

FIG. 15 is a diagram illustrating a screen example in a debate function in accordance with the present disclosure.

FIG. 16 is a flowchart for describing a flow of an information processing method in accordance with the present disclosure.

FIG. 17 is a diagram illustrating an example of a screen in a sum-up function in accordance with the present disclosure.

FIG. 18 is a diagram illustrating an example of a screen in a sum-up function in accordance with the present disclosure.

FIG. 19 is a flowchart for describing a flow of an information processing method in accordance with the present disclosure.

FIG. 20 is a diagram illustrating an example of a screen in a talk function in accordance with the present disclosure.

FIG. 21 is a block diagram illustrating a variation of an apparatus configuration in accordance with the present disclosure.

FIG. 22 is a block diagram illustrating a variation of an apparatus configuration in accordance with the present disclosure.

FIG. 23 is a block diagram illustrating a variation of an apparatus configuration in accordance with the present disclosure.

FIG. 24 is a block diagram illustrating a hardware configuration of a computer which functions as each of apparatuses in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining technical means employed in the example embodiments described below. Alternatively, the present invention also encompasses, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing Apparatus)

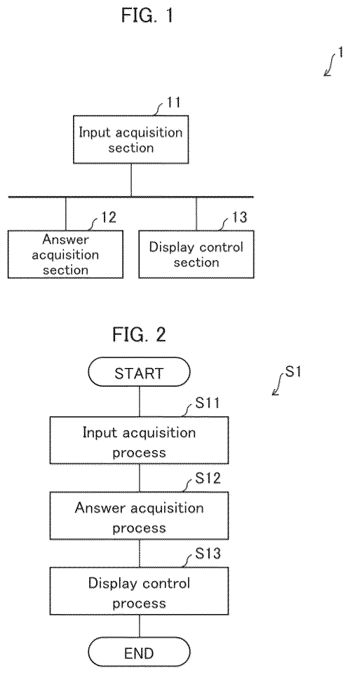

The following description will discuss a configuration of an information processing apparatus 1 with reference to FIG. 1. FIG. 1 is a block diagram illustrating a configuration of an information processing apparatus 1. As illustrated in FIG. 1, the information processing apparatus 1 includes an input acquisition section 11, an answer acquisition section 12, and a display control section 13.

The input acquisition section 11 acquires a first request from a user. The answer acquisition section 12 acquires first answers respectively from a first machine learning model and a second machine learning model in response to the first request while causing the second machine learning model to refer to a first answer obtained from the first machine learning model. The display control section 13 causes a display apparatus to display a first answer set which includes the first answers obtained respectively from the first machine learning model and the second machine learning model.

### (Example Advantage of Information Processing Apparatus)

As described above, the information processing apparatus 1 employs the configuration in which: the input acquisition section 11 acquires a first request from a user; the answer acquisition section 12 acquires first answers respectively from a first machine learning model and a second machine learning model in response to the first request while causing the second machine learning model to refer to a first answer obtained from the first machine learning model; and the display control section 13 causes a display apparatus to display a first answer set which includes the first answers obtained respectively from the first machine learning model and the second machine learning model. Therefore, according to the information processing apparatus 1, it is possible to bring about an example advantage of allowing a user to more efficiently obtain useful information from a plurality of services. Specifically, a first answer obtained from the second machine learning model is generated with reference to a first answer obtained from the first machine learning model. Therefore, it is possible to efficiently obtain a more useful first answer set, as compared with a case where answers are simply obtained collectively from the first machine learning model and the second machine learning model.

### (Flow of Information Processing Method)

The following description will discuss a flow of an information processing method S1, with reference to FIG. 2. FIG. 2 is a flowchart illustrating the flow of the information processing method S1. As illustrated in FIG. 2, the information processing method S1 includes an input acquisition process S11, an answer acquisition process S12, and a display control process S13.

In the input acquisition process S11, at least one processor acquires a first request from a user.

In the answer acquisition process S12, the at least one processor acquires first answers respectively from a first machine learning model and a second machine learning model in response to the first request while causing the second machine learning model to refer to a first answer obtained from the first machine learning model.

In the display control process S13, the at least one processor causes a display apparatus to display a first answer set which includes the first answers obtained respectively from the first machine learning model and the second machine learning model.

### (Example Advantage of Information Processing Method)

As described above, the information processing method S1 employs the configuration in which: in the input acquisition process S11, the at least one processor acquires a first request from a user; in the answer acquisition process S12, the at least one processor acquires first answers respectively from a first machine learning model and a second machine learning model in response to the first request while causing the second machine learning model to refer to the first answer obtained from the first machine learning model; and in the display control process S13, the at least one processor causes a display apparatus to display a first answer set which includes the first answers obtained respectively from the first machine learning model and the second machine learning model. Therefore, according to the information processing method S1, it is possible to bring about an example advantage of allowing a user to more efficiently obtain useful information from a plurality of services. Specifically, a first answer obtained from the second machine learning model is generated with reference to a first answer obtained from the first machine learning model. Therefore, it is possible to efficiently obtain a more useful first answer set, as compared with a case where answers are simply obtained collectively from the first machine learning model and the second machine learning model.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Overview of Information Processing System 1A)

An information processing system 1A is a system which provides an answer service that presents answers from a plurality of machine learning models ML in response to a request from a user. The plurality of machine learning models ML include the first machine learning model and the second machine learning model described above. In other words, the number of machine learning models ML may be two, or three or more. In a case where attention is paid to two of the plurality of machine learning models ML, the second example embodiment described below is similarly described by replacing “the plurality of machine learning models ML” with “the first machine learning model and the second machine learning model”.

The information processing system 1A includes a user terminal 10 and a plurality of servers 20. Provision of the plurality of servers 20 also plays a role of load balancing and/or ensuring redundancy. Each of the servers 20 is managed by, for example, a company that provides a service to a user, and utilizes a machine learning model ML to provide a part of the service of the company. Each of the servers 20 generates, using the machine learning model ML, an answer in response to a request from a user. The user terminal 10 functions as an interface between the user and the servers 20. The user terminal 10 receives a request from the user, generates a query based on the request, and transmits the generated query to the servers 20. The servers 20 each generate an answer in response to the query using the machine learning model ML and transmits the generated answer to the user terminal 10. Thus, answers in response to the request are transmitted to the user. The information processing system 1A can efficiently present information to the user using answers by the plurality of machine learning models. As a result, the user can obtain necessary information in a short time.

In the present example embodiment, the information processing system 1A provides a basic function, an intervention function, a flip function, a give-up function, a debate function, a sum-up function, and a talk function of the answer service.

The basic function is a function to acquire, from the plurality of machine learning models ML in turn, answers in response to a request from a user. In the basic function, answers from 2nd and subsequent machine learning models ML are obtained with reference to answers from respective machine learning models ML which have been acquired before then. A request and an answer in the basic function are referred to as a first request and a first answer, respectively. In response to a single first request, first answers are obtained from the respective plurality of machine learning models ML. The plurality of first answers can be different from each other. The plurality of first answers are correctively referred to as a first answer set.

The intervention function is a function to acquire, from the plurality of machine learning models ML in turn, new answers by adding a request (intervening) by the user in response to a first answer obtained by the basic function. In the intervention function, new answers from 2nd and subsequent machine learning models ML are obtained with reference to new answers from respective machine learning models ML which have been acquired before then. A request added and a new answer in the intervention function are referred to as a second request and a second answer, respectively. In response to a single second request, second answers are obtained from the respective plurality of machine learning models ML. The plurality of second answers are correctively referred to as a second answer set. Note that the intervention function may be further carried out on the second answer and subsequent answers. A new request and a new answer in the intervention function carried out on an n-th answer are referred to as an (n+1)th request and an (n+1)th answer, respectively, and a plurality of (n+1)th answers are correctively referred to as an (n+1)th answer set.

The flip function is a function in which the user changes (flips) an order of using the plurality of machine learning models ML in response to answers obtained by the basic function. In the flip function, a new first answer is obtained from at least one machine learning model ML with reference to first answers which have already been obtained from machine learning models ML which has been used before that machine learning model ML according to the changed order.

The give-up function is a function to refrain from presenting (give up) an answer obtained from a certain machine learning model ML in a case where the answer is disadvantageous. A disadvantageous answer means that the answer is more disadvantageous than an answer obtained from at least one of machine learning models ML which have been used before then.

The debate function is a function to acquire, from the plurality of machine learning models ML, a second answer set with reference to the first answer set. Note that the debate function may be further carried out with reference to the second and subsequent answer sets. By carrying out the debate function with reference to an n-th answer set, an (n+1)th answer set is obtained. Note that the n-th answer set in the debate function and the n-th answer set in the intervention function described above can be different from each other because different pieces of information are referred to by the machine learning models ML. In the debate function, second and subsequent answer sets are obtained without user intervention. Meanwhile, in the intervention function, second and subsequent answer sets are obtained by intervention of the user.

Such a debate function is available, for example, in a situation where a user needs to make a selection between products provided by two particular companies. By using the information processing system 1A, the user can cause machine learning models of the respective companies to hold a debate on the two products. The user can make a selection based on not only one-way information provision from each of the companies but also specific comparison points and relative superiority.

The sum-up function is a function to present a summary (sum up) of answers from the plurality of machine learning models ML. In the sum-up function, at least a first answer set is summed up. In a case where answer sets up to an n-th answer set have been obtained, the first answer set through the n-th answer set are summed up.

The talk function is a function in which an operator associated with any of the machine learning models ML directly talks with a user in place of the machine learning model ML. The talk function may be started based on a request from the user or may be started based on a request from the operator. The present example embodiment will be described mainly with reference to a case of starting the talk function based on a request from the operator.

### (Configuration of Information Processing System 1A)

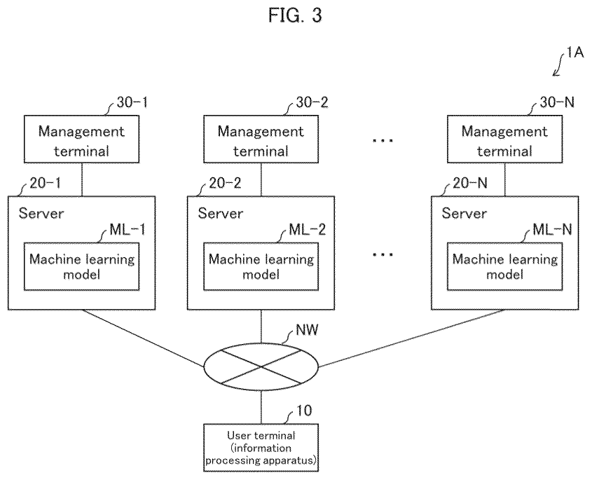

The following description will discuss the configuration of the information processing system 1A, with reference to FIG. 3. FIG. 3 is a block diagram illustrating the configuration of the information processing system 1A. The information processing system 1A includes a user terminal 10, a plurality of servers 20-i (i=1, 2, . . . , N; N is a natural number of 2 or more), and a plurality of management terminals 30-i. The user terminal 10 is an example of the information processing apparatus. FIG. 3 illustrates a single user terminal 10. Note, however, that the number of user terminals 10 included in the information processing system 1A may be two or more.

The user terminal 10 and the servers 20-i are communicably connected to each other via a network NW. The network NW may be constituted by including, but not limited to, a wireless local area network (LAN), a wired LAN, a WAN, a mobile data communication network, and the like. The server 20-i and the management terminal 30-i are communicably connected to each other. The server 20-i and the management terminal 30-i may be connected to each other via an organization LAN (not illustrated) that manages the server 20-i, or may be connected to each other via the network NW. FIG. 3 illustrates an example in which a single management terminal 30-i is connected to a single server 20-i. Note, however, that a plurality of management terminals 30-i may be connected to a single server 20-i.

The server 20-i stores a machine learning model ML-i. Note that the machine learning model ML-i may be communicably connected to the server 20-i instead of being stored in the server 20-i. In such a case, the machine learning model ML-i and the server 20-i may be connected to each other via the foregoing organization LAN, or may be connected to each other via the network NW.

Hereinafter, when it is not necessary to particularly distinguish between the plurality of servers 20-i, the plurality of servers 20-i are each simply referred to as a server 20. Moreover, when it is not necessary to particularly distinguish between the plurality of management terminals 30-i, the plurality of management terminals 30-i are each simply referred to as a management terminal 30. Moreover, when it is not necessary to particularly distinguish between the plurality of machine learning models ML-i, the plurality of machine learning models ML-i are each simply referred to as a machine learning model ML.

### (Machine Learning Model ML)

The machine learning model ML is a model which generates an answer in response to a request. For example, upon receipt of input of a query generated based on a request, the machine learning model ML outputs an answer in response to the query. For example, the machine learning model ML is constituted by a language model. The language model may be, for example, but not limited to, a model called a large language model (LLM). The language model is a generative model which uses language as input and outputs language. The language model is a model which has learned a relationship between words in a sentence, and generates, from a target character string, a relevant character string related to the target character string. By using a language model which has learned various contexts and sentences, it is possible to generate a relevant character string of proper content related to a target character string.

For example, the following description will discuss a case where a language model is used in a question answering. The language model accepts, as a target character string, input of a question “What kind of country is Japan?”. The language model generates, as an answer to the question, a character string such as “Japan is an island country in the northern hemisphere, and . . . ”.

A training method of a language model is not particularly limited, and may be, for example, training the language model to output at least one sentence which includes an input character string. Specific examples of the language model include a generative pre-training-2 (GPT-2) and GPT-3 which output a sentence including an input character string by predicting a character string that would highly probably follow the input character string. Other examples of the language model include text-to-text transfer transformer (T5), bidirectional encoder representations from transformers (BERT), robustly optimized BERT approach (ROBERTa), efficiently learning an encoder that classifies token replacements accurately (ELECTRA), and the like.

A character string which is generated by the language model is not limited to a natural language. The language model may output, for example, an artificial language (such as a program source code) with respect to a character string which is input in a natural language. For example, the language model accepts, as a target character string, input of a question “How can data containing a specific character string be acquired from a database?”. The language model may output a program source code for carrying out database processing. Alternatively, the language model may output a natural language corresponding to a character string which has been input in an artificial language. Content generated by the language model is not limited to a character string. The language model may generate, for example, image data, video data, audio data, or another data form corresponding to the input character string.

A machine learning model ML-i is managed by an organization different from those of the other machine learning models ML-j (i+j), and has been trained to generate an answer that is appropriate for the organization in response to a query. For example, in a case where the same query is input into the machine learning models ML-i and ML-j, answers output from those models can be different from each other. For example, it is assumed that a machine learning model ML-1 is managed by a company “A” and a machine learning model ML-2 is managed by a company “B”. Moreover, it is assumed that the company A sells stuffed dogs for 100 yen each, and the company B sells stuffed dogs for 80 yen each. In this case, in response to a query “I want a stuffed dog”, an answer “It is 100 yen each” is output from the machine learning model ML-1, and an answer “It is 80 yen each” is output from the machine learning model ML-2. Note that an organization that manages each of the machine learning models ML-i will be referred to also as a management organization hereinafter. Examples of the management organization include, but not limited to, a company.

The plurality of machine learning models ML are used in turn by the user terminal 10 (described later). Hereinafter, a k-th machine learning model ML that is used is referred to as a machine learning model ML<k> (k=1, 2, 3, . . . ). An order of using the plurality of machine learning models ML can be changed. Therefore, an index “i” for identifying the machine learning model ML-i and an index “k” for indicating an ordinal number at which the machine learning model ML-i is applied do not necessarily match each other. For example, the machine learning model ML-1 can be a machine learning model ML<1> which is used 1st and can be a machine learning model ML<N> which is used N-th. In some cases, a servers 20-i which stores a machine learning model ML<k> used k-th is referred to as a server 20<k>.

An order in which the plurality of machine learning models ML are used may be predetermined or may be dynamically decided. In a case where the order is dynamically decided, for example, a random order may be decided by the answer acquisition section 112 as the order. Alternatively, an order may be decided in accordance with an instruction from a user. The order can be changed in accordance with an instruction from a user. For example, the order may be decided based on advertisement costs from management organizations that manage the machine learning models ML. For example, a machine learning model ML which is applied later can refer to first answers from more other machine learning models ML to generate a more useful first answer. Therefore, the order may be decided such that a management organization that pays more for advertising comes later in the order.

### (Configuration of User Terminal 10)

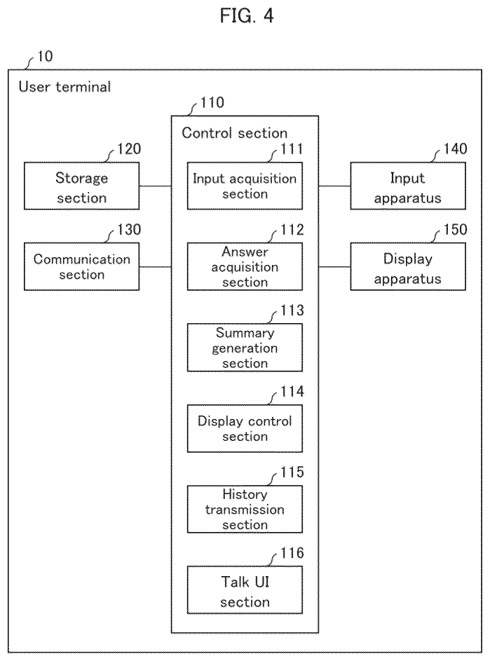

The following description will discuss a configuration of the user terminal 10, with reference to FIG. 4. The user terminal 10 is a computer used by a user. The user terminal 10 includes a control section 110, a storage section 120, a communication section 130, an input apparatus 140, and a display apparatus 150. The control section 110 comprehensively controls the sections of the user terminal 10. The storage section 120 stores various kinds of data and a program used by the control section 110. The communication section 130 carries out communication with the other apparatuses under control of the control section 110. The input apparatus 140 may be constituted by a mouse, a touch pad, a keyboard, or a combination of some of or all of these. The display apparatus 150 may be constituted by a liquid crystal display or an organic electro luminescence (EL) display. The input apparatus 140 and the display apparatus 150 may be configured by a touch panel which is integrally formed. Note that some of or all of the storage section 120, the communication section 130, the input apparatus 140, and the display apparatus 150 may be incorporated in the user terminal 10 or may be externally connected as peripheral apparatuses. The user terminal 10 can further include a microphone, a speaker, and the like, or those apparatuses may be externally connected.

The control section 110 includes an input acquisition section 111, an answer acquisition section 112, a summary generation section 113, a display control section 114, a history transmission section 115, and a talk user interface (hereinafter, UI) section 116. The input acquisition section 111 an is example configuration for realizing the input acquisition means. The answer acquisition section 112 is an example configuration for realizing the answer acquisition means. The summary generation section 113 is an example configuration for realizing the summary generation means. The display control section 114 is an example configuration for realizing the display control means. The history transmission section 115 is an example configuration for realizing the history transmission means. The talk UI section 116 is an example configuration for realizing the talk request reception means.

The input acquisition section 111 acquires a first request from a user. Note that an “n-th request from the user” (n is a natural number) may be information input through the input apparatus 140 by the user or may be information stored in advance in the storage section 120. The first request may include an instruction (hereinafter, referred to also as a target designation instruction) to designate, among the plurality of machine learning models ML, a plurality of machine learning models ML from which answers are to be acquired.

The input acquisition section 111 may acquire a second request from the user in response to display of the first answer set. The first answer set includes first answers generated by the respective plurality of machine learning models ML in response to the first request. Hereinafter, the input acquisition section 111 may repeat acquiring an (n+1)th request from the user in response to display of an n-th answer set. In a case where n is 2 or more, the n-th answer set includes (n−1)th answers which have been generated by the respective plurality of machine learning models ML in response to the (n−1)th request.

The input acquisition section 111 may acquire, in response to display of the first answer set, an instruction (hereinafter referred to also as an order change instruction) from the user to change an order of using the plurality of machine learning models ML. Note that an “instruction from the user” may be made by operation which has been carried out by the user using the input apparatus 140. Note that the input acquisition section 111 may carry out, not only display of the first answer set, but also acquisition of the order change instruction described above in response to display of an arbitrary n-th answer set where n is 2 or more. The input acquisition section 111 may acquire an instruction (hereinafter, referred to also as a talk response instruction) from a user to respond to a talk request. The talk request is transmitted from at least one management terminal 30.

The answer acquisition section 112 acquires answers using the respective plurality of machine learning models ML. In the present example embodiment, the “process of acquiring answers using the machine learning models ML” includes: (i) a process of generating a query to be input into a machine learning model ML; (ii) a process of transmitting the generated query to a server 20 which stores the machine learning model ML; and (iii) a process of receiving, from the server 20, an answer generated by the machine learning model ML.

For example, the answer acquisition section 112 acquires first answers in response to the first request from the respective plurality of machine learning models ML while using the respective plurality of machine learning models ML in turn. A first answer obtained from a machine learning model ML<k> used k-th is referred to as a first answer <k>. At this time, the answer acquisition section 112 causes each of 2nd and subsequent machine learning models ML<k> to refer to at least one of first answers <1> through <k−1> obtained from at least one of machine learning models ML<1> through ML<k−1> which have been used before the machine learning model ML<k>. In the present example embodiment, it is assumed that each of 2nd and subsequent machine learning models ML<k> is caused to refer to first answers <1> through <k−1> obtained from respective machine learning models ML<1> through ML<k−1> which have been used before the machine learning model ML<k>. For example, the answer acquisition section 112 generates, based on the first request, a query to be input into the 1st machine learning model ML<1>. The answer acquisition section 112 generates, based on the first request and the first answers <1> through <k−1>, queries to be input into the 2nd and subsequent machine learning models ML<k>. The answer acquisition section 112 may also acquire a second answer set after display of the first answer set. The second answer set may be acquired in response to a second request input by the user in response to display of the first answer set. The second answer set may be acquired based on the first answer set without input of a second request by the user.

The following description will discuss a case where a second answer set is acquired in response to a second request. For example, the answer acquisition section 112 acquires second answers in response to the second request from the respective plurality of machine learning models ML while using the respective plurality of machine learning models ML in turn. At this time, the answer acquisition section 112 causes each of 2nd and subsequent machine learning models ML<k> to refer to at least one of second answers <1> through <k−1> obtained from at least one of machine learning models ML<1> through ML<k−1> which have been used before the machine learning model ML<k>. In the present example embodiment, it is assumed that each of 2nd and subsequent machine learning models ML<k> is caused to refer to second answers <1> through <k−1> obtained from respective machine learning models ML<1> through ML<k−1> which have been used before the machine learning model ML<k>.

For example, the answer acquisition section 112 generates, based on the first request, the first answer set, and the second request, a query to be input into the 1st machine learning model ML<1>. The answer acquisition section 112 generates, based on the first request, the first answer set, the second request, and the second answers <1> through <k−1>, queries to be input into the 2nd and subsequent machine learning models ML<k>. Note that the answer acquisition section 112 may further acquire an n-th answer set in response to an n-th request.

The following description will discuss a case in which a second answer set is acquired based on a first answer set without input of a second request by a user. For example, the answer acquisition section 112 acquires, based on the first answer set, second answers from the respective plurality of machine learning models ML while using the respective plurality of machine learning models ML in turn. At this time, the answer acquisition section 112 causes each of 2nd and subsequent machine learning models ML<k> to further refer to at least one of second answers <1> through <k−1> obtained from at least one of machine learning models ML<1> through ML<k−1> which have been used before the machine learning model ML<k>. In the present example embodiment, it is assumed that each of 2nd and subsequent machine learning models ML<k> is caused to refer to second answers <1> through <k−1> obtained from respective machine learning models ML<1> through ML<k−1> which have been used before the machine learning model ML<k>.

For example, the answer acquisition section 112 generates, based on the first request and the first answer set, a query to be input into the 1st machine learning model ML<1>. The answer acquisition section 112 generates, based on the first request, the first answer set, and the second answers <1> through <k−1>, queries to be input into the 2nd and subsequent machine learning models ML<k>. Note that the answer acquisition section 112 may sequentially repeat the process of further acquiring an (n+1)th answer set based on an n-th answer set for each integer of n=2 or more. In this case, an end condition for the repetition is determined. For example, as an end condition, it may be defined to end at a time point when a fourth answer set is obtained. Note, however, that the present example embodiment is not limited to this.

The answer acquisition section 112 may acquire a new first answer based on an order change instruction with respect to the first answer set. A changed order is referred to as k(new). For example, the acquisition section 112 causes at least one machine learning model ML<k(new)> from among the plurality of machine learning models ML to refer to first answers <1> through <k(new)−1> obtained from respective machine learning models ML<1> through ML<k(new)−1> which are earlier in the changed order than the machine learning model ML<k(new)>. Thus, the answer acquisition section 112 acquires, from the machine learning model ML<k(new)>, a new first answer <k(new)> in response to the first request. Note that the answer acquisition section 112 may acquire a new n-th answer based on an order change instruction with respect to an n-th answer set.

The answer acquisition section 112 may control a machine learning model ML to refrain from outputting a disadvantageous answer. In this case, each of the plurality of machine learning models ML<k> is controlled as follows. That is, in a case where a first answer <k> which can be generated by the machine learning model ML<k> in response to the first request is disadvantageous as compared with at least one of first answers <1> which have been generated by the other machine learning models ML<1> (k≠1) which are referred to, the machine learning model ML<k> is controlled so as not to generate a first answer <k> which can be generated by the machine learning model ML<k>. Note that, even for an n-th answer <k> which can be generated in response to an n-th request, the answer acquisition section 112 may control a machine learning model ML to refrain from outputting a disadvantageous answer. A specific example of such a control method will be described later.

Note that, in a case where the answer acquisition section 112 has acquired a target designation instruction from a user, the answer acquisition section 112 uses in turn a plurality of target machine learning models ML which have been designated to acquire the foregoing n-th answer set (n=1, 2, . . . ), instead of using the plurality of machine learning models ML in turn.

The summary generation section 113 generates a summary based on at least the first answer set. Note that, in a case where the summary generation section 113 has obtained not only the first answer set but also an m-th answer set (m is an integer of 2 or more), the summary is generated based on the first answer set through the m-th answer set.

The display control section 114 causes the display apparatus 150 to display a first answer set which includes first answers obtained from the respective plurality of machine learning models ML. The display control section 114 may cause the display apparatus 150 to display a second answer set which includes second answers obtained from the respective plurality of machine learning models ML. The display control section 114 may cause the display apparatus 150 to display an n-th answer set which includes n-th answers obtained from the respective plurality of machine learning models ML.

The display control section 114 may cause the display apparatus 150 to display a new first answer <k(new)> which has been acquired in response to an order change instruction with respect to the first answer set. Here, the display control section 114 may display the new first answer <k(new)> in addition to the first answer set. Assuming that an ordinal number before the change of the machine learning model ML which has generated the new first answer <k(new)> is k(prev), the display control section 114 may display the new first answer <k(new)> in place of the previous first answer <k(prev)>.

The display control section 114 may cause the display apparatus 150 to display the summary. The display control section 114 may cause the display apparatus 150 to display a user interface for carrying out a talk between the user and an operator of at least one management terminal 30 in response to a talk response instruction. Such a user interface is generated by the talk UI section 116 (described later).

The history transmission section 115 transmits a history of information displayed on the display apparatus 150 to management terminals 30 which correspond to the respective plurality of machine learning models ML. The history transmission section 115 transmits the history to the plurality of servers 20 so as to transmit the history to the management terminals 30 connected to the servers 20. The history transmission section 115 may transmit information displayed on the display apparatus 150 to a plurality of management terminals 30 at predetermined intervals or each time information on the display apparatus 150 is updated. The history transmission section 115 may transmit, to the management terminal 30, a difference between information transmitted at and before the previous time and information currently displayed on the display apparatus 150.

The talk UI section 116 receives a talk request from at least one management terminal 30. The talk request is information indicating that an operator of the management terminal 30 wishes to talk with the user. The talk UI section 116 provides a user interface for carrying out a talk directly between a user of the user terminal 10 and an operator who uses the management terminal 30.

### (Configuration of Server 20)

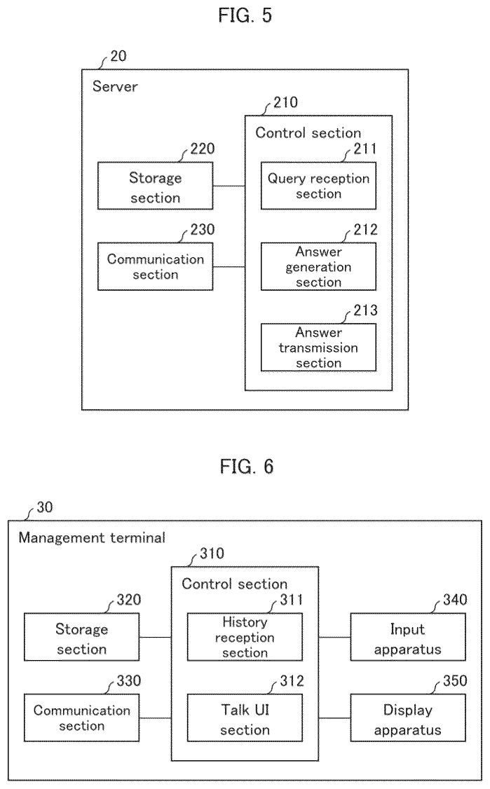

The following description will discuss a configuration of the server 20, with reference to FIG. 5. FIG. 5 is a block diagram illustrating the configuration of the server 20. The server 20 is managed by a management organization that manages a machine learning model ML.

The server 20 includes a control section 210, a storage section 220, and a communication section 230. The control section 210 comprehensively controls the sections of the server 20. The storage section 220 stores various kinds of data and a program used by the control section 210. The communication section 230 carries out communication with the other apparatuses under control of the control section 210. Note that a part of or all of the storage section 220 and the communication section 230 may be incorporated in the user terminal 10 or may be externally connected as peripheral apparatuses.

The storage section 220 stores the machine learning model ML. The control section 210 includes a query reception section 211, an answer generation section 212, and an answer transmission section 213. The query reception section 211 receives a query from the user terminal 10. The answer generation section 212 obtains an output answer by inputting the query into the machine learning model ML. The answer transmission section 213 transmits the obtained answer to the user terminal 10. The control section 210 relays information that is transmitted and received between the user terminal 10 and the management terminal 30.

### (Configuration of Management Terminal 30)

The following description will discuss a configuration of a management terminal 30, with reference to FIG. 6. FIG. 6 is a block diagram illustrating a configuration of a management terminal. The management terminal 30 is a terminal used by an operator who belongs to an organization that manages the server 20. The management terminal 30 includes a control section 310, a storage section 320, a communication section 330, an input apparatus 340, and a display apparatus 350. The control section 310 comprehensively controls the sections of the management terminal 30. The storage section 320 stores various kinds of data and a program used by the control section 310. The communication section 330 carries out communication with the other apparatuses under control of the control section 310. The input apparatus 340 may be constituted by a mouse, a touch pad, a keyboard, or a combination of some of or all of these. The display apparatus 350 may be constituted by a liquid crystal display or an organic electro luminescence (EL) display. The input apparatus 340 and the display apparatus 350 may be configured by a touch panel which is integrally formed. Note that some of or all of the storage section 320, the communication section 330, the input apparatus 340, and the display apparatus 350 may be incorporated in the management terminal 30 or may be externally connected as peripheral apparatuses. The management terminal 30 can further include a microphone, a speaker, and the like, or those apparatuses may be externally connected.

The control section 310 includes a history reception section 311 and a talk UI section 312. The history reception section 311 receives, from the user terminal 10, a history of exchange between the user and each machine learning model ML and causes the display apparatus 350 to display the received history. The talk UI section 312 causes the display apparatus 350 to display a user interface for carrying out a talk between the user of the user terminal 10 and an operator who uses the management terminal 30. For example, upon receipt of operation to request the talk input by the operator, the talk UI section 312 transmits the talk request to the user terminal 10. For example, in a case where the operator of the management terminal 30 has determined that a management organization to which the operator belongs is disadvantageous as compared with the other management organizations while browsing in real time exchange between the user of the user terminal 10 and each machine learning model ML, the operator can carry out operation of transmitting a talk request.

### (Basic Function: Flow of Information Processing Method S10)

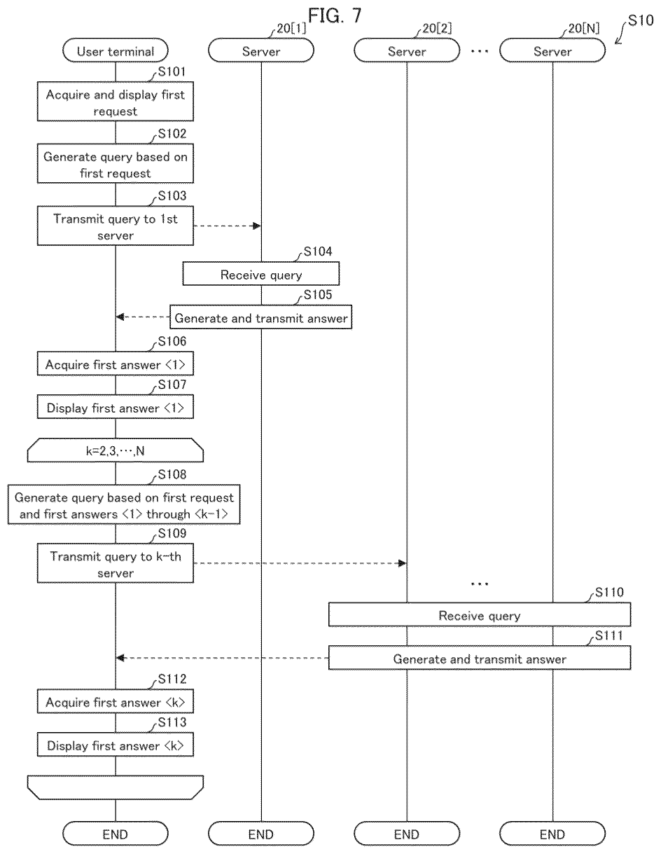

The following description will discuss a flow of an information processing method S10 which is carried out by the information processing system 1A, with reference to FIG. 7. FIG. 7 is a flowchart for describing the flow of the information processing method S10. The information processing method S10 realizes a basic function of an answer service which is provided by the information processing system 1A. As illustrated in FIG. 7, the information processing method S10 includes steps S101 through S113.

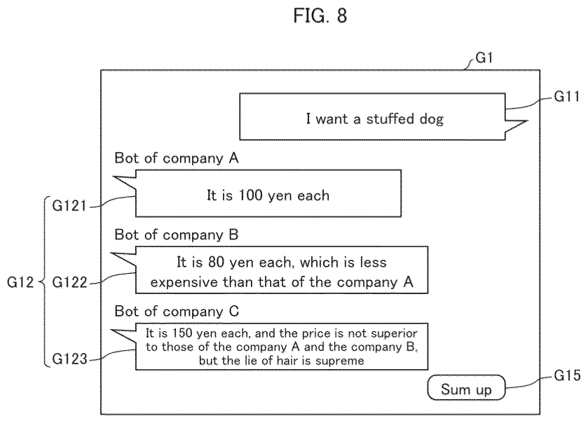

Step S101 is an example of the input acquisition process. In step S101, the input acquisition section 111 of the user terminal 10 acquires a first request which has been input on the input apparatus 140 by a user. The display control section 114 causes the display apparatus 150 to display the acquired first request. The following description will discuss an example of a first request displayed on the display apparatus 150 in step S101, with reference to FIG. 8.

FIG. 8 illustrates an example of a screen which is displayed on the display apparatus 150 in the basic function. In FIG. 8, a screen example G1 includes a first request G11 which has been acquired in step S101. The first request G11 is content “I want a stuffed dog”. In the example of FIG. 8, the number of servers 20 is three (i.e., N=3). A server 20-1 is managed by a company A, and a machine learning model ML-1 which is stored in the server 20-1 has been trained to generate an answer that is appropriate for the company A. A server 20-2 is managed by a company B, and a machine learning model ML-2 which is stored in the server 20-2 has been trained to generate an answer that is appropriate for the company B. A server 20-3 is managed by a company C, and a machine learning model ML-3 which is stored in the server 20-3 has been trained to generate an answer that is appropriate for the company C. In this example, an order of using the machine learning models ML-1 through ML-3 is set to this order at least in the basic function. That is, the server 20-1 stores the machine learning model ML<1> which is used 1st, and therefore referred to also as a server 20<1>. Similarly, the servers 20-2 and 20-3 are referred to also as servers 20<2> and 20<3>, respectively.

Steps S102 through S106 in FIG. 7 are an example of at least a part of the answer acquisition process, and indicate an example of a series of processes for acquiring a first answer <1> from the 1st machine learning model ML<1>. In step S102, the answer acquisition section 112 of the user terminal 10 generates, based on the first request, a query to be input into the 1st machine learning model ML<1>. For example, the answer acquisition section 112 may generate, based on the first request, a query in a form conforming to the machine learning model ML<1>. The conforming form is a form for obtaining an appropriate answer from the machine learning model ML<1>. For example, the answer acquisition section 112 may use the first request as it is as a query, or may convert the first request in accordance with a predetermined conversion rule and use the converted first request as a query. For example, the answer acquisition section 112 may generate a query in a form conforming to the machine learning model ML<1> by inputting a first request into a query generative model (not illustrated) that can generate a query in the conforming form. Such a query generative model may be, but not limited to, a language model. For example, from the first request “I want a stuffed dog”, a query “The user is considering purchase of a stuffed dog” may be generated.

In step S103, the answer acquisition section 112 transmits the generated query to the server 20<1> which stores the machine learning model ML<1>. In step S104, the query reception section 211 of the server 20<1> receives the query. In step S105, the answer generation section 212 of the server 20<1> inputs the received query into the machine learning model ML<1> to obtain an output answer. The answer includes content appropriate for a management organization of the server 20<1> in response to the first request. The answer generation section 212 transmits the output answer to the user terminal 10. In step S106, the answer acquisition section 112 of the user terminal 10 acquires, as a first answer <1>, the answer received from the server 20<1>.

Step S107 is an example of at least a part of the display control process. In step S107, the display control section 114 causes the display apparatus 150 to display the acquired first answer <1>. The following description will discuss an example of the first answer <1> displayed on the display apparatus 150 in step S107, with reference to FIG. 8. In FIG. 8, the screen example G1 includes a first answer G121 “It is 100 yen each”. The first answer G121 is an example of the first answer <1>. The first answer G121 has been generated by the machine learning model ML<1> of the company A in response to the first request G11 “I want a stuffed dog”.

Subsequently, steps S108 through S113 are carried out for each of k=2, 3, . . . , N. Steps S108 through S112 are an example of at least a part of the answer acquisition process, and indicate an example of a series of processes for acquiring a first answer <k> from each of 2nd and subsequent machine learning models ML<k>. Step S113 is an example of at least a part of the display control process.

First, a case of k=2, where a first answer <2> is acquired, will be described. In step S108, the answer acquisition section 112 generates, based on the first request and the first answer <1>, a query to be input into the 2nd machine learning model ML<2>. For example, the answer acquisition section 112 may generate a query “I want a stuffed dog. Company A: It is 100 yen each” using, in addition to the first request and the first answer <1>, information “company A” which is a management organization of the machine learning model ML<1>. For example, the answer acquisition section 112 may generate, based on the first request and the first answer <1>, a query in a form conforming to the machine learning model ML<2>. For example, the answer acquisition section 112 may generate a query in the conforming form by inputting the first request and the first answer <1> into the foregoing query generative model. A specific example of the query generative model is as described above, and therefore detailed descriptions thereof will not be repeated. For example, from the first request “I want a stuffed dog” and the first answer <1> “It is 100 yen each”, a query “The user is considering purchase of a stuffed dog, and the company A seems to provide it for 100 yen each” may be generated.

In step S109, the answer acquisition section 112 transmits the generated query to the server 20<2> which stores the machine learning model ML<2>. In step S110, the query reception section 211 of the server 20<2> receives the query. In step S111, the answer generation section 212 of the server 20<2> inputs the received query into the machine learning model ML<2> to obtain an output answer. The answer generation section 212 transmits the output answer to the user terminal 10. In step S112, the answer acquisition section 112 of the user terminal 10 acquires, as a first answer <2>, the answer received from the server 20<2>.

In step S113, the display control section 114 causes the display apparatus 150 to display the acquired first answer <2>. The first answer <2> includes content appropriate for a management organization of the server 20<2> as an answer to the first request, and can be different from the first answer <1> responding to the same first request. The following description will discuss an example of the first answer <2> displayed on the display apparatus 150 in step S113, with reference to FIG. 8. In FIG. 8, the screen example G1 includes a first answer G122 “It is 80 yen each, which is less expensive than that of the company A”. The first answer G122 is an example of the first answer <2>. The first answer G122 is an answer of the company B in response to the first request G11 “I want a stuffed dog” and has been generated by the machine learning model ML<2> of the company B with reference to the first answer G121 “It is 100 yen each” of the company A.

Subsequently, a case of k=3, where a first answer <3> is acquired, will be described. In step S108, the answer acquisition section 112 generates, based on the first request and the first answers <1> and <2>, a query to be input into the 3rd machine learning model ML<3>. For example, the answer acquisition section 112 may generate a query “I want a stuffed dog. Company A: It is 100 yen each. Company B: 80 yen each” using, in addition to the first request and the first answers <1> and <2>, information “company A” and “company B” which are management organizations of the respective machine learning models ML<1> and ML<2>. For example, the answer acquisition section 112 may generate, based on the first request and the first answers <1> and <2>, a query in a form conforming to the machine learning model ML<3>. For example, the answer acquisition section 112 may generate a query in the conforming form by inputting the first request and the first answers <1> and <2> into the foregoing query generative model. A specific example of the query generative model is as described above, and therefore detailed descriptions thereof will not be repeated. For example, from the first request “I want a stuffed dog”, the first answer <1> “It is 100 yen each”, and the first answer <2> “It is 80 yen each”, a query “The user is considering purchase of a stuffed dog, and the company A seems to provide it for 100 yen each. The company B seems to provide it at a lower price, i.e., 80 yen each” may be generated.

Steps S109 through S113 in a case of k=3 can be described in the substantially same manner, by replacing <2> with <3> in the descriptions for the case of k=2. Thus, a first answer <3> acquired in step S112 includes content appropriate for a management organization of the server 20<3> as an answer to the first request, and can be different from the first answer <1> and the second answer <2> responding to the same first request.

The following description will discuss an example of the first answer <3> displayed on the display apparatus 150 in step S113, with reference to FIG. 8. In FIG. 8, the screen example G1 includes a first answer G123 “It is 150 yen each, and the price is not superior to those of the company A and the company B, but the lie of hair is supreme”. The first answer G123 is an example of the first answer <3>. The first answer G123 is an answer of the company C in response to the first request G11 “I want a stuffed dog” and has been generated by the machine learning model ML<3> of the company C with reference to the first answer G121 “It is 100 yen each” of the company A and the first answer G122 “It is 80 yen each” of the company B.

Subsequently, steps S108 through S113 are carried out for each k while increasing k by 1. When a series of the steps is completed for k=N, the information processing method S10 ends. A series of steps in each of cases where k=4 or more is substantially the same as those in the cases of k=2 and 3, and therefore detailed descriptions thereof will not be repeated. In the example of FIG. 8, N is 3. Therefore, the first answers G121 through G123 are displayed, and the information processing method S10 ends. The first answers G121 through G123 constitute an example of a first answer set G12.

### (Intervention Function: Flow of Information Processing Method S20)

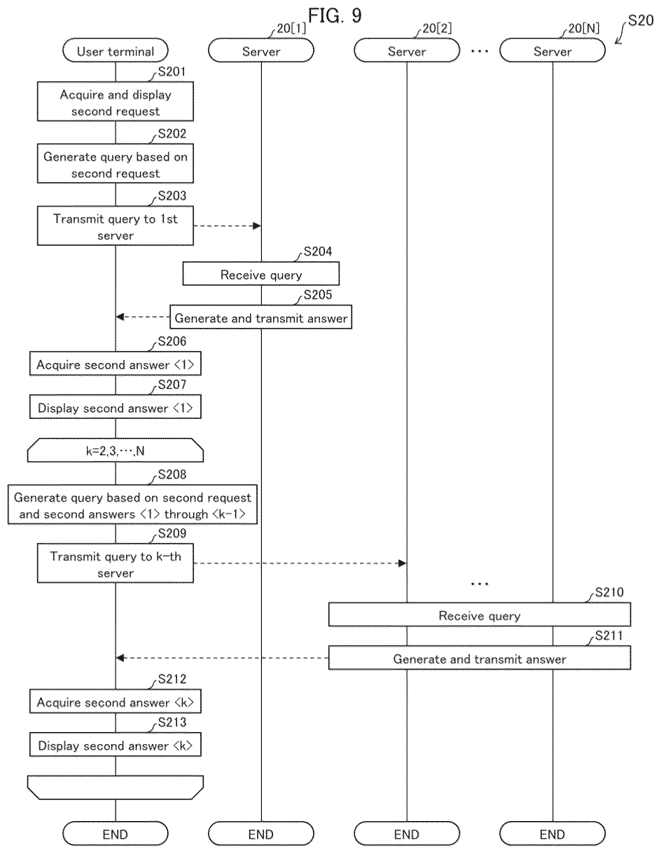

Next, the following description will discuss a flow of an information processing method S20 which is carried out by the information processing system 1A, with reference to FIG. 9. FIG. 9 is a flowchart for describing the flow of the information processing method S20. The information processing method S20 realizes an intervention function of the answer service which is provided by the information processing system 1A. The information processing method S20 is carried out following the information processing method S10. For example, the information processing method S20 is started in a state in which the screen example G1 illustrated in FIG. 8 is displayed on the display apparatus 150. As illustrated in FIG. 9, the information processing method S20 includes steps S201 through S213.

Steps S201 through S213 can be described in the substantially same manner by replacing the first request with a second request and replacing the first answer with a second answer in steps S101 through S113 of the information processing method S10. Note, however, that the following points differ.

In step S202, the answer acquisition section 112 of the user terminal 10 may generate a query to be input into the 1st machine learning model ML<1> based on not only the second request but also one or both of the first request and the first answer set which have been obtained until then. In step S208, the answer acquisition section 112 of the user terminal 10 may generate a query to be input into the k-th machine learning model ML<k> based on not only the second request and second answers <1> through <k−1> but also one or both of the first request and the first answer set which have been obtained until then.

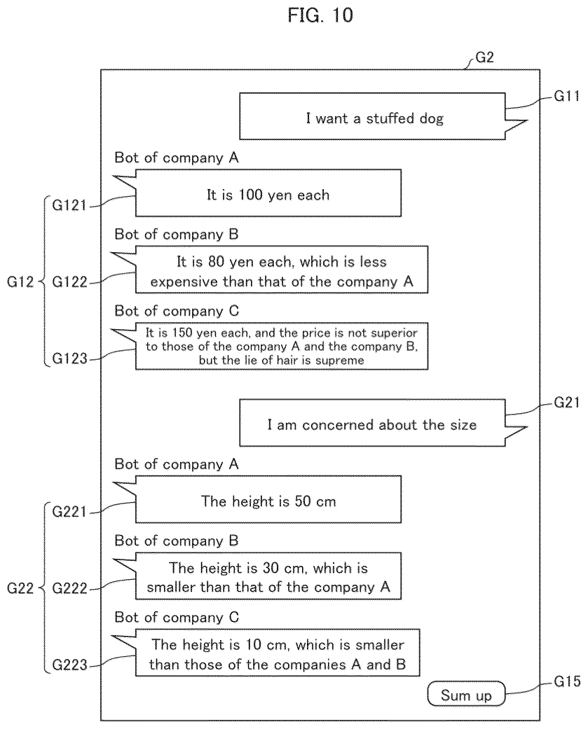

The following description will discuss an example of a second request displayed on the display apparatus 150 in step S201, with reference to FIG. 10. FIG. 10 illustrates an example of a screen which is displayed on the display apparatus 150 in the intervention function. Note that, in FIG. 10, the first request G11 and the first answer set G12 included in the screen example G2 have already been displayed by execution of the information processing method S10 (basic function). Those are as described with reference to FIG. 8, and therefore detailed descriptions thereof will not be repeated. The following description will discuss a second request G21 and a second answer set G22 which are displayed by execution of the following information processing method S20 (intervention function).

The screen example G2 includes a second request G21 “I am concerned about the size” which has been acquired in step S201. In the example of the screen example G2, a query generated in step S202 is generated based on the first request G11 and the first answer set G12, in addition to the second request G21. For example, it is assumed that a query “The user is considering purchase of a stuffed dog. There were answers from companies regarding the price, but the user seems to be concerned about the size of the stuffed toy” has been generated.

The screen example G2 includes a second answer G221 “The height is 50 cm (centimeters)” which is displayed in step S207. The second answer G221 is an example of the second answer <1>. The second answer G221 is an answer by the company A in response to the second request G21 “I am concerned about the size” and has been generated by the machine learning model ML<1> of the company A. The screen example G2 includes a second answer G222 “The height is 30 cm, which is smaller than that of the company A” which is displayed in step S213 (k=2). The second answer G222 is an example of the second answer <2>. The second answer G222 is an answer by the company B in response to the second request G21 “I am concerned about the size” and has been generated by the machine learning model ML<2> of the company B with reference to the second answer G221 “The height is 50 cm” of the company A. The screen example G2 also includes a second answer G223 “The height is 10 cm, which is smaller than those of the companies A and B” which is displayed in step S213 (k=3). The second answer G223 is an example of the second answer <3>. The second answer G223 is an answer by the company C in response to the second request G21 “I am concerned about the size” and has been generated by the machine learning model ML<3> of the company C with reference to the second answer G221 “The height is 50 cm” of the company A and the second answer G222 “The height is 30 cm, which is smaller than that of the company A” of the company B.

In the example of FIG. 10, N is 3. Therefore, when the second answers G221 through G223 are displayed, the information processing method S20 ends. The second answers G221 through G223 constitute an example of the second answer set G22.

As described above, in the user terminal 10, the configuration is employed in which: the input acquisition section 111 acquires a second request which has been input by the user in response to display of a first answer set; when acquiring, from the respective plurality of machine learning models ML, second answers to the second request while using the machine learning models ML in turn, the answer acquisition section 112 causes each of 2nd and subsequent machine learning models ML to refer to a second answer which has been obtained from at least one machine learning model ML used before that machine learning model ML; and the display control section 114 causes the display apparatus 150 to display a second answer set which includes second answers obtained from the respective plurality of machine learning models ML.

Therefore, according to the user terminal 10, in addition to the foregoing example advantages brought about by the information processing apparatus 1, it is possible to make a second request by the user intervention in response to answers obtained from the plurality of machine learning models ML, and it is possible to collectively obtain a second answer set from the machine learning models ML in accordance with the intervention. Similarly to the first answer, the second answer is generated with reference to the other second answers which have been obtained from the other machine learning models ML used before then. Therefore, it is possible to bring about an example advantage of efficiently obtaining a more useful second answer set, as compared with a case where answers are simply obtained collectively from a plurality of machine learning models ML.

### (Give-Up Function: Variation of Information Processing Methods S10 and S20)

The give-up function is implemented by altering step S108 in the information processing method S10 and step S208 in the information processing method S20 as follows.

In step S108, as described above, the answer acquisition section 112 generates, based on a first request and first answers <1> through <k−1>, a query to be input into a k-th machine learning model ML<k>. Furthermore, in a case where a generable first answer <k> is disadvantageous as compared with at least one of the first answers the <1> through <k−1>, answer acquisition section 112 may add, to the query, information to carry out control for refraining from outputting the generable first answer <k>. For example, such information to carry out control may be, but not limited to, content “If you determine that an answer from your own company is more disadvantageous than an answer from the other company, it is not necessary to answer”.

Thus, in a case where a generable first answer <k> is disadvantageous as compared with at least one of the first answers <1> through <k−1>, each of machine learning models ML<k> used 2nd and later is controlled so as not to output the generable first answer <k>. Alteration in step S208 can be described similarly by replacing the first request with a second request and replacing the first answer with a second answer in the description of the alteration in step S108.

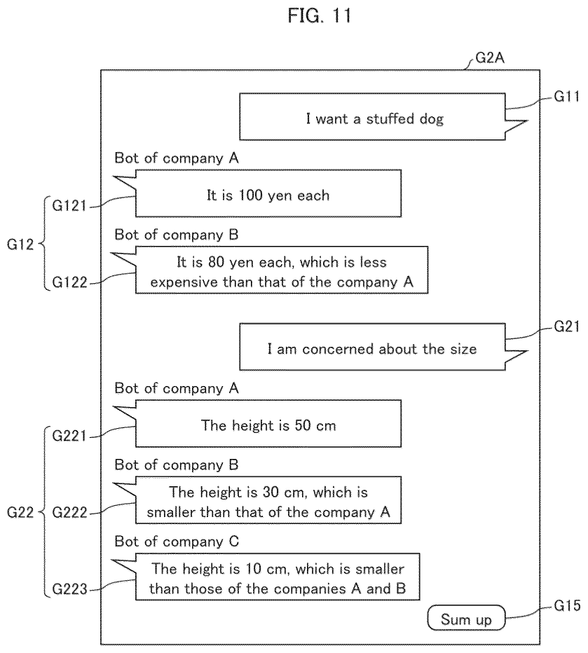

In a case where steps S108 and S208 are altered as described above, the screen example G2 illustrated in FIG. 10 is altered as in a screen example G2A illustrated in FIG. 11. FIG. 11 is a diagram illustrating an example of a screen to which the give-up function is applied. The screen example G2A differs from the screen example G2 in that the first answer set G12 does not include the first answer G123 from the company C. This is because, in step S108, a query as follows is generated: “The user is considering purchase of a stuffed dog, and the company A seems to provide it for 100 yen each. The company B seems to provide it at a lower price, i.e., 80 yen each. Note that, if you determine that an answer from your own company is disadvantageous as compared with an answer from the other company, it is not necessary to answer”. In response to the query, in step S111, the machine learning model ML<2> of the company C does not output an answer because the price of the stuffed dog of the company C is disadvantageous as compared with the first answer G121 of the company A and the first answer G122 of the company B. Thus, as shown in the screen example G2A, a first answer <3> of the company C which is disadvantageous as compared with those of the companies A and B is not displayed.

Note that, in the screen example G2A, the second answer set G22 includes, similarly to the screen example G2, a second answer G221 from the company A, a second answer G222 from the company B, and a second answer G223 from the company C. This is because of the following reason: it is unclear whether the user is seeking a large stuffed toy or a small stuffed toy, and therefore it cannot be said that the second answer G223 from the company C is necessarily disadvantageous as compared with the second answer G221 from the company A and the second answer G222 from the company B. Therefore, in step S111, the machine learning model ML<2> of the company C determines that it is not necessarily disadvantageous that the stuffed dog of the company C is smaller than those of the company A and the company B, and outputs the second answer G223.

As described above, the user terminal 10 employs the configuration in which: each of the plurality of machine learning models ML is controlled by the answer acquisition section 112 as follows. In a case where a first answer which can be generated by that machine learning model in response to a first request is disadvantageous as compared with at least one of first answers which have been generated by the other machine learning models which are referred to, that machine learning model ML is controlled so as not to generate the generable first answer.

Therefore, according to the user terminal 10, it is possible to bring about, in addition to the example advantages of the information processing apparatus 1 described above, an example advantage of maintaining a situation which is not disadvantageous while refraining from presenting, to a user, information which is disadvantageous to a management organization of each machine learning model ML. Moreover, it is possible, even for the user, to bring about an example advantage as follows: no disadvantageous information is included in the first answer set, and therefore visibility is improved and it is possible to easily find a useful first answer.

### (Flip Function: Flow of Information Processing Method S30)

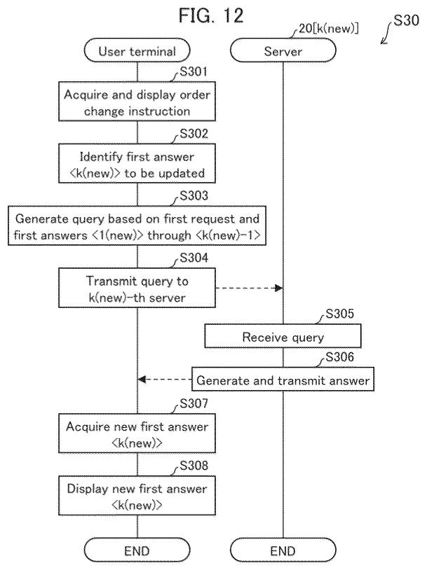

Next, the following description will discuss a flow of an information processing method S30 which is carried out by the information processing system 1A, with reference to FIG. 12. FIG. 12 is a flowchart for describing the flow of the information processing method S30. The information processing method S30 realizes a flip function of the answer service which is provided by the information processing system 1A. The information processing method S30 is carried out following the information processing method S10. For example, the information processing method S30 is started in a state in which the screen example G1 illustrated in FIG. 8 is displayed on the display apparatus 150. As illustrated in FIG. 12, the information processing method S30 includes steps S301 through S308.

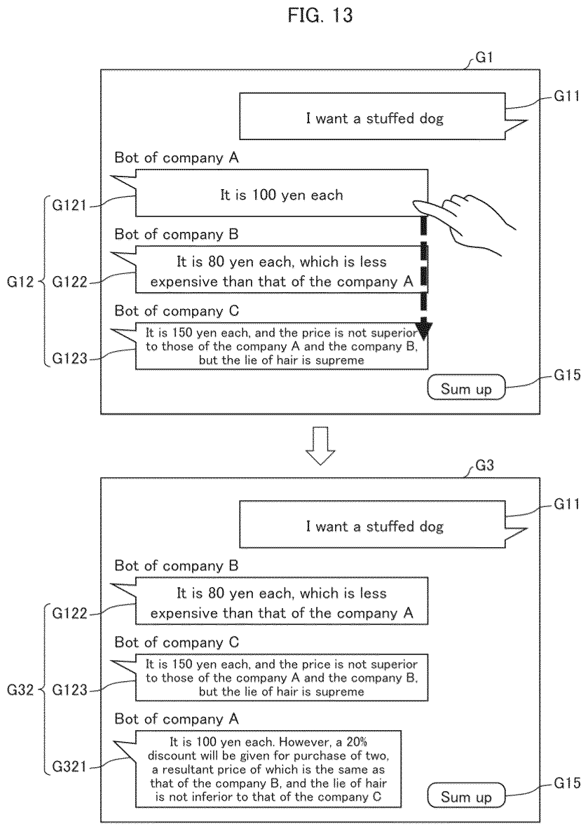

In step S301, the input acquisition section 111 acquires an order change instruction input by a user in response to display of the first answer set. The order change instruction represents an instruction to change an order of using the plurality of machine learning models ML, as described above. For example, the user may drag, as an order change instruction, a region of an arbitrary first answer displayed on the display apparatus 150 to a region indicating an order after the change. The following description will discuss an example of operation of inputting an order change instruction, with reference to FIG. 13. FIG. 13 is a diagram illustrating a screen example in the flip function. A screen example G1 illustrated in the upper half of FIG. 13 has a configuration similar to the screen example G1 illustrated in FIG. 8. In this example, it is assumed that a user wants to obtain a first answer from the company A lastly. That is, the user wants, from the company A, an answer with reference to first answers from the company B and the company C. In this case, as illustrated in FIG. 10, the user drags the first answer G121 from the company A in the screen example G1 so that the first answer G121 overlaps the first answer G123 from the company C which has been last obtained at that point in time. Thus, an order change instruction to change, as below, an order of using the plurality of machine learning models ML is input: the order of machine learning models ML-1 (company A), M-2 (company B), and M-3 (company C) is changed to an order of machine learning models ML-2 (company B), M-3 (company C), and M-1 (company A). Note that operation of inputting an order change instruction is not limited to the example described above.

In step S302 of FIG. 12, the answer acquisition section 112 applies the changed order to identify a first answer <k(new)> to be updated. Here, all of first answers <1> through <N> may be identified as the first answer <k(new)> to be updated. In this case, in other words, the information processing method S1 which is the basic function is repeated again while applying the changed order. A part of the first answers <1> through <N> may be designated as the first answer <k(new)> to be updated. For example, a first answer which has been operated by a user to give an order change instruction may be identified as a first answer <k(new)> to be updated. This is because it is highly likely that, for the first answer which has been operated by the user, the user wants to know a new first answer to which the changed order is applied. Alternatively, the user can select whether to use all of or a part of first answers <1> through <N> as a first answer <k(new)> to be updated. Here, the description will continue while assuming that a first answer which has been operated by the user has been identified as a first answer <k(new)> to be updated. In the example of FIG. 13, the first answer G121 from the company A which has been operated by the user is identified as a first answer <k(new)> to be updated.

In step S303 of FIG. 12, the answer acquisition section 112 generates a query based on a first request and first answers <1(new)> through <k(new)−1>. “1(new)” indicates that an ordinal number in the changed order is 1st. The first answers <1(new)> through <k(new)−1> may have been included in the previous first answer set.

For example, in the example of FIG. 13, an ordinal number of the machine learning model ML-1 of the company A in the changed order is 3rd, and k(new)=3. A first answer <1(new)> is the first answer G122 which has already been obtained from the machine learning model ML-2 whose ordinal number in the changed order is 1st. A first answer <k(new)−1>=first answer <2(new)> is the first answer G123 which has already been obtained from the machine learning model ML-3 whose ordinal number in the changed order is 2nd. In this case, the answer acquisition section 112 generates a query based on the first request, the first answer G122, and the first is answer G123. For example, a query “The user considering purchase of a stuffed dog. The company B can provide it for 80 yen each, and the company C appeals that the lie of hair is good although it is 150 yen each” is generated.

In step S304, the answer acquisition section 112 transmits the generated query to a server 20<k(new)> which stores a machine learning model ML<k(new)>. In step S305, the query reception section 211 of the server 20<k(new)> receives the query. In step S306, the answer generation section 212 of the server 20<k(new)> inputs the received query into the machine learning model ML<k(new)> to obtain an output answer. The answer generation section 212 transmits the output answer to the user terminal 10. In step S307, the answer acquisition section 112 of the user terminal 10 acquires, as a new first answer <k(new)>, the answer received from the server 20<k(new)>.

In step S308, the display control section 114 causes the display apparatus 150 to display the acquired first answer <k(new)>. For example, the display control section 114 may display the new first answer <k(new)> while adding the new first answer <k(new)> to the first answer set which has already been displayed. Alternatively, the display control section 114 may display the new first answer <k(new)> in place of the first answer <k(new)> in the first answer set which has already been displayed. In this case, the display control section 114 may rearrange, in the first answer set which has already been displayed, the display order of the first answers <1(new)> through <N (new)> which include the updated new first answer <k(new)> in accordance with the changed order.

The following description will discuss an example of the new first answer <k(new)> displayed on the display apparatus 150 in step S308, with reference to FIG. 13. A screen example G3 illustrated in the lower half of FIG. 13 differs from the screen example G1 in the upper half in that the screen example G3 includes a first answer G321 “It is 100 yen each. However, a 20% discount will be given for purchase of two, a resultant price of which is the same as that of the company B, and the lie of hair is not inferior to that of the company C”, instead of the first answer G121. The first answer G321 is an answer by the company A in response to the first request “I want a stuffed dog” and has been obtained by updating the first answer G121. The first answer G321 is generated by referring to the first answer G122 from the company B and the first answer G123 from the company C which could not be referred to before the order is changed. Further, in the screen example G3, the display order of the first answer G122 from the company B, the first answer G123 from the company C, and the first answer G321 from the company A has been rearranged according to the changed order.

Thus, in the example of FIG. 13, in a case where the user is interested in the company A, the user can change the order of using the company A to a later ordinal number (e.g., last). Thus, the user can obtain, instead of the first answer G121 from the company A which has obtained without referring to the first answers G122 and G123 of the other companies until then, the more useful first answer G321 from the company A which has been obtained by referring to the first answers G122 and G123 of the other companies.

Note that the user may give an order change instruction to change the order such that a management organization that the user is not interested in comes earlier, instead of the order change instruction of changing the order such that a management organization that the user is interested in comes later as illustrated in FIG. 13.

As described above, the user terminal 10 employs the configuration in which: the input acquisition section 111 acquires an instruction which has been input by the user in response to display of a first answer set and which changes an order of using the plurality of machine learning models ML; the answer acquisition section 112 acquires a new first answer in response to a first request from at least one machine learning model ML among the plurality of machine learning models ML by causing that machine learning model ML to refer to first answers which have been obtained from machine learning models ML used before that machine learning model ML in the changed order; and the display control section 114 causes the display apparatus 150 to display the new first answer which has been obtained from that machine learning model ML.

Therefore, according to the user terminal 10, it is possible to bring about an example advantage of allowing a user to change an order of using machine learning models ML, in addition to the foregoing example advantages brought about by the information processing apparatus 1. For example, it is possible for a user to obtain a more useful new first answer from a machine learning model ML in which the user is interested. For example, a user can cause a machine learning model ML in which the user is interested to refer to more first answers from the other machine learning models by changing the order such that the machine learning model ML in which the user is interested comes later (e.g., last). As a result, the user can efficiently obtain a more useful first answer from the machine learning model ML in which the user is interested.

### (Debate Function: Flow of Information Processing Method S40)

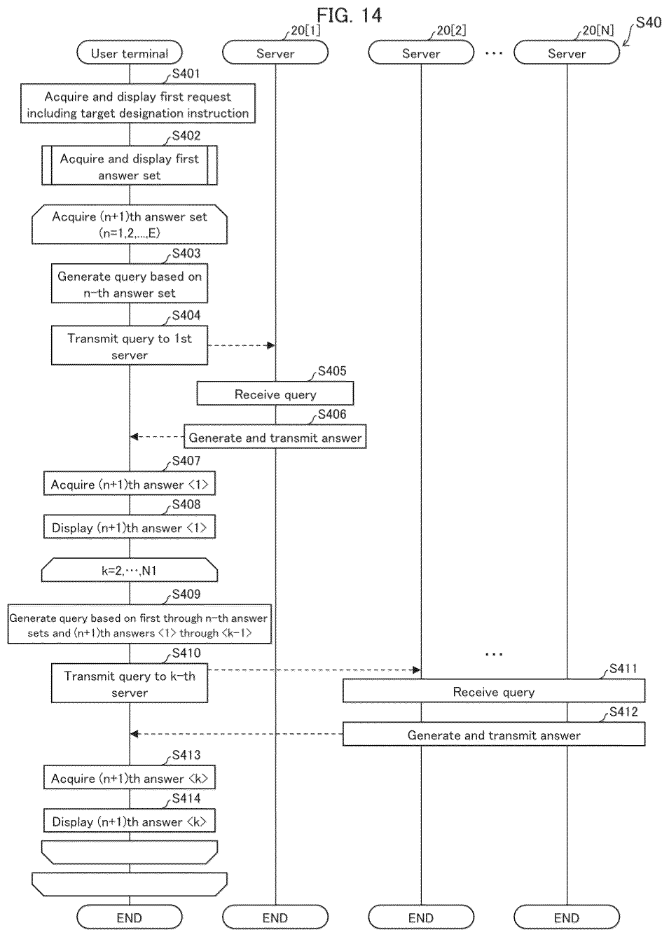

Next, the following description will discuss a flow of an information processing method S40 which is carried out by the information processing system 1A, with reference to FIG. 14. FIG. 14 is a flowchart for describing the flow of the information processing method S40. The information processing method S40 realizes a debate function of the answer service which is provided by the information processing system 1A. As illustrated in FIG. 14, the information processing method S40 includes steps S401 through S414.

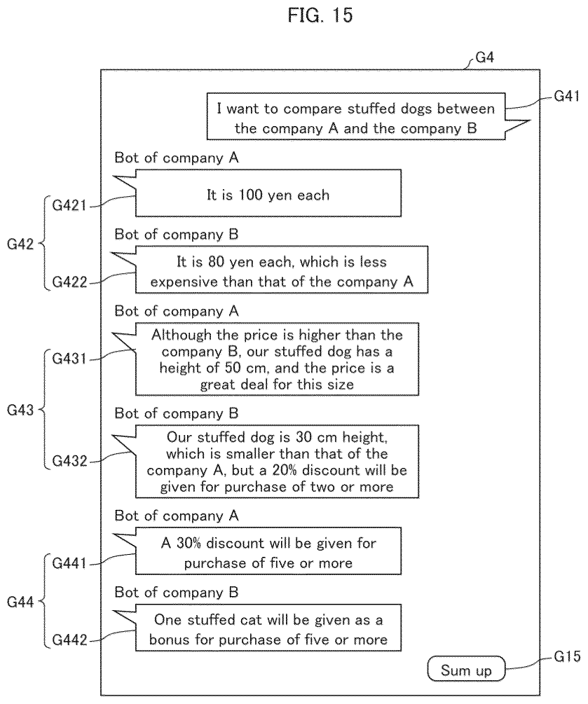

In step S401, the answer acquisition section 112 of the user terminal 10 acquires a first request which includes a target designation instruction. As described above, the target designation instruction is an instruction to designate, among the plurality of machine learning models ML, a plurality of machine learning models ML from which answers are to be acquired. The display control section 114 causes the display apparatus 150 to display the acquired first request. The following description will discuss an example of a first request displayed on the display apparatus 150 in step S401, with reference to FIG. 15.

FIG. 15 illustrates an example of a screen which is displayed on the display apparatus 150 in the debate function. In FIG. 15, a screen example G4 includes a first request G41 which has been acquired in step S401. The first request G41 is content “I want to compare stuffed dogs between the company A and the company B”. The first request G41 includes a target designation instruction. The target designation instruction designates, among a plurality of machine learning models ML from which the information processing system 1A can acquire answers, machine learning models ML of the company A and the company B as answer acquisition targets.

Note that, in step S401, the first request including the target designation instruction is not necessarily input in the answer service which is provided by the information processing system 1A as in the example of FIG. 15. That is, the first request including the target designation instruction may be input in an external service that cooperates with the information processing system 1A. For example, the information processing system 1A may cooperate with an external search service to acquire, as a first request including a target designation instruction, information input on a search result screen of the search service. Such a search result screen includes, for example, a search keyword (e.g., “stuffed dog”) which has been input by a user, and a list of search results (e.g., a list of links to sales sites of respective companies which sell stuffed dogs). The search service may dispose, by cooperating with the information processing system 1A, a button to invoke the debate function and selection buttons (such as check boxes) for selecting search results on the search result screen. In this case, the user can input a first request which includes a target designation instruction by pressing the button to invoke the debate function while selecting a plurality of search results to be compared (e.g., links of the company A and the company B). Thus, in step S401, the information processing system 1A may acquire, as a first request including the target designation instruction, the selected search results and the search keyword from the cooperative search service.

Next, in step S402 of FIG. 14, the answer acquisition section 112 acquires a first answer set responding to the first request, using the plurality of designated machine learning models ML in turn. The display control section 114 causes the display apparatus 150 to display the first answer set. Details of the process of step S402 can be similarly described by replacing “a plurality of machine learning models ML” with “a plurality of designated machine learning models ML” and replacing “N”, which indicates the number of machine learning models ML, with “N1” in the descriptions of steps S102 through S113 of the information processing method S10. “N1” indicates the number of the plurality of designated machine learning models ML, and N1 is 2 in the example of FIG. 15.

The following description will discuss an example of a first answer set displayed on the display apparatus 150 in step S402, with reference to FIG. 15. In FIG. 15, the screen example G4 includes a first answer set G42. The first answer set G42 includes a first answer G421 from the company A and a first answer G422 from the company B. The first answer G421 “It is 100 yen each” from the company A has been generated by inputting, into the machine learning model ML<1> of the company A, a query based on the first request “I want to compare stuffed dogs between the company A and the company B”. The first answer G422 “It is 80 yen each, which is less expensive than that of the company A” from the company B has been generated by inputting, into the machine learning model ML<2> of the company B, a query based on the first request G41 and the first answer G421 from the company A.

Steps S403 through S414 in FIG. 14 are an example of a process of acquiring an (n+1)th answer set with reference to an n-th answer set, and are repeated for n=1, 2, . . . , E. “E” indicates the number of repetitions, which may be predetermined or may be designated by a user. In a case where “E” is designated by a user, a first request acquired in step S401 may include the number of repetitions. First, the following description will discuss a case where n=1, i.e., a series of processes of acquiring a second answer set with reference to a first answer set.

First, in step S403, the answer acquisition section 112 generates, based on the first answer set, a query to be input into the 1st machine learning model ML<1>. The answer acquisition section 112 may generate a query based on the first request in addition to the first answer set. Examples of a query generation method include: a method in which a query is generated by connecting a first request and a first answer set as they are; a method in which a first request and a first answer set are converted into a query in accordance with a predetermined conversion rule; a method in which a first request and a first answer set are input into a query generative model; and the like. The query generative model is as described in the description of the information processing method S10, and therefore detailed descriptions thereof will not be repeated. For example, based on the first request G41 and the first answer set G42 in FIG. 15, a query as follows may be generated: “Regarding a stuffed dog, the company B can provide it for 80 yen each, which is less expensive than 100 yen of the company A. Based on this information, please answer an advantage of the stuffed toy of the company A”.

In step S404, the answer acquisition section 112 transmits the generated query to the server 20<1> which stores the machine learning model ML<1>. In step S405, the query reception section 211 of the server 20<1> receives the query. In step S406, the answer generation section 212 of the server 20<1> inputs the received query into the machine learning model ML<1> to obtain an output answer. The answer generation section 212 transmits the output answer to the user terminal 10. In step S407, the answer acquisition section 112 of the user terminal 10 acquires, as a second answer <1>, the answer received from the server 20<1>. In step S408, the display control section 114 causes the display apparatus 150 to display the acquired second answer <1>.

The following description will discuss an example of the second answer <1> displayed on the display apparatus 150 in step S408, with reference to FIG. 15. In FIG. 15, the screen example G4 includes a second answer G431 “Although the price is higher than the company B, our stuffed dog has a height of 50 cm, and the price is a great deal for this size”. The second answer G431 is an example of the second answer <1>. The second answer G431 has been generated by the machine learning model ML<1> of the company A in response to the first request G41 and the first answer set G42.

Steps S409 through S414 in FIG. 14 are an example of a process for acquiring a second answer <k> from each of 2nd and subsequent machine learning models ML<k>, and are repeated for k=2, . . . , N1. First, a case of k=2, where a second answer <2> is acquired, will be described. In step S409, the answer acquisition section 112 generates, based on the first answer set and the second answer <1>, a query to be input into the 2nd machine learning model ML<2>. The answer acquisition section 112 may generate a query based on the first request in addition to the first answer set and the second answer <1>. A query generation method is substantially the same as the method (described in step S403) of generating a query for acquiring the second answer <1>, and therefore detailed descriptions thereof will not be repeated. For example, based on the first request G41, the first answer set G42, and the second answer G431 in FIG. 15, a query as follows may be generated: “Regarding a stuffed dog, the company A asserts that it is a good deal to purchase a stuffed toy of such a size of 50 cm high for 100 yen, although the price which is 100 yen each is higher than that of the company B. Based on this information, please answer an advantage of the stuffed toy of the company B”.

In step S410, the answer acquisition section 112 transmits the generated query to the server 20<2> which stores the machine learning model ML<2>. In step S411, the query reception section 211 of the server 20<2> receives the query. In step S412, the answer generation section 212 of the server 20<2> inputs the received query into the machine learning model ML<2> to obtain an output answer. The answer generation section 212 transmits the output answer to the user terminal 10. In step S413, the answer acquisition section 112 of the user terminal 10 acquires, as a second answer <2>, the answer received from the server 20<2>. In step S414, the display control section 114 causes the display apparatus 150 to display the acquired second answer <2>.

The following description will discuss an example of the second answer <2> displayed on the display apparatus 150 in step S414, with reference to FIG. 15. In FIG. 15, the screen example G4 includes a second answer G432 “Our stuffed dog is 30 cm height, which is smaller than that of the company A, but a 20% discount will be given for purchase of two or more”. The second answer G432 is an example of the second answer <2>. The second answer G432 has been generated by the machine learning model ML<2> of the company B in response to the first request G41, the first answer set G42, and the second answer G431 from the company A.

Subsequently, steps S409 through S414 are carried out for each k while increasing k by 1. When a series of the steps is completed for k=N1, the process of acquiring a second answer set ends. A series of steps in each of cases where k=3 or more is substantially the same as those in the case of k=2, and therefore detailed descriptions thereof will not be repeated. In the example of FIG. 15, N1 is 2. Therefore, the processes of displaying the second answers G431 and G432 and acquiring the second answer set G43 have been completed.

Next, the following description will discuss a case where n=2, i.e., a series of processes of acquiring a third answer set with reference to the second answer set. The process of acquiring the second answer set can be described in the substantially same manner by replacing the second answer with a third answer in the descriptions of the case of acquiring the second answer set. Note, however, that information referred to when generating a query in step S403 and step S409 is different from the case where the second answer set is acquired. In the following description, the different point is mainly described.

In step S403, the answer acquisition section 112 generates, based on the first answer set and the second answer set, a query to be input into the 1st machine learning model ML<1>. The answer acquisition section 112 may generate a query based on the first request in addition to the first answer set and the second answer set. The query generation method is as described in the description of step S403 in the case of n=2, and therefore detailed descriptions thereof will not be repeated. For example, based on the first request G41, the first answer set G42, and the second answer set G43 in FIG. 15, a query as follows may be generated: “Regarding a stuffed dog, the company B asserts that they can provide it for 80 yen each, which is less expensive than 100 yen of the company A and that, although the size is smaller than 50 cm of the company A, a 20% discount will be given for purchase of two or more. Based on this information, please answer an advantage of the stuffed toy of the company A”.

Subsequently, steps S404 through S408 are carried out in a manner similar to that in the case of n=2. Thus, the display apparatus 150 displays a third answer <1>. The following description will discuss an example of the third answer <1> displayed on the display apparatus 150 in step S408, with reference to FIG. 15. In FIG. 15, the screen example G4 includes a third answer G441 “A 30% discount will be given for purchase of five or more”. The third answer G441 is an example of the third answer <1>. The third answer G441 has been generated by the machine learning model ML<1> of the company A in response to the first request G41, the first answer set G42, and the second answer set G43.

In step S409 in a case of k=2, the answer acquisition section 112 generates, based on the first answer set, the second answer set and the third answer <1>, a query to be input into the 2nd machine learning model ML<2>. The answer acquisition section 112 may generate a query based on the first request in addition to the first answer set, the second answer set, and the third answer <1>. The query generation method is as described in the description of step S403 in the case of n=2, and therefore detailed descriptions thereof will not be repeated. For example, based on the first request G41, the first answer set G42, the second answer set G43, and the third answer G441 in FIG. 15, a query as follows may be generated: “Regarding a stuffed dog, the company A asserts to offer a 30% discount for purchase of five or more, in response to the assertion of the company B that they offer a 20% discount for purchase of two or more. Based on this information, please answer an advantage of the stuffed toy of the company B”.

Subsequently, steps S410 through S414 are carried out in a manner similar to that in the case of n=2. Thus, the display apparatus 150 displays a third answer <2>. The following description will discuss an example of the third answer <2> displayed on the display apparatus 150 in step S414, with reference to FIG. 15. In FIG. 15, the screen example G4 includes a third answer G442 “One stuffed cat will be given as a bonus for purchase of five or more”. The third answer G442 is an example of the third answer <2>. The third answer G442 has been generated by the machine learning model ML<1> of the company A in response to the first request G41, the first answer set G42, and the second answer set G43.

Subsequently, steps S409 through S414 are carried out for each k while increasing k by 1. When a series of the steps is completed for k=N1, the process of acquiring a third answer set ends. A series of steps in each of cases where k=3 or more is substantially the same as those in the case of k=2, and therefore detailed descriptions thereof will not be repeated. In the example of FIG. 15, N1 is 2. Therefore, the process of displaying the third answers G441 and G442 and acquiring the third answer set G44 has been completed.

Subsequently, steps S403 through S414 are carried out for each n while increasing n by 1. When a series of the steps is completed for n=E, the information processing method S40 ends. A series of steps in each of cases where n=4 or more is substantially the same as those in the cases of n=2 and 3, and therefore detailed descriptions thereof will not be repeated. In the example of FIG. 15, E is 3. Therefore, the third answers G441 and G442 are displayed, and the information processing method S40 has been completed.

As described above, in the user terminal 10, the configuration is employed in which: when acquiring second answers based on the first answer set from the respective plurality of machine learning models ML while using the plurality of machine learning models ML in turn, the answer acquisition section 112 causes each of 2nd and subsequent machine learning models ML to refer to a second answer which has been obtained from at least one machine learning model ML used before that machine learning model ML; and the display control section 114 causes the display apparatus 150 to display a second answer set which includes second answers obtained from the respective plurality of machine learning models ML.

Therefore, according to the user terminal 10, it is possible to bring about, in addition to the foregoing example advantages brought about by the information processing apparatus 1, example advantages that: by causing the plurality of machine learning models ML to refer to a first answer set obtained before then to obtain a second answer set, it is possible to cause the machine learning models ML to discuss assertions on their sides, and it is possible to obtain useful information through, as in a debate, pointing out a weak point of a competitor or re-emphasizing superiority of its own company.

### (Sum-Up Function: Flow of Information Processing Method S50)

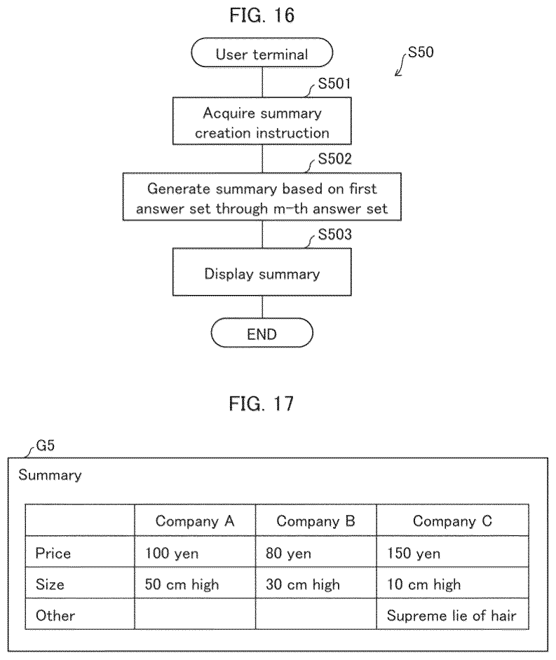

Next, the following description will discuss a flow of an information processing method S50 which is carried out by the information processing system 1A, with reference to FIG. 16. FIG. 16 is a flowchart for describing the flow of the information processing method S50. The information processing method S50 realizes a sum-up function of the answer service which is provided by the information processing system 1A. As illustrated in FIG. 16, the information processing method S50 includes steps S501 through S503.

In step S501, the input acquisition section 111 acquires an instruction to create a summary, the instruction having been input by a user. The instruction to create a summary may be input by, for example, operating a summary button G15 included in the screen examples G1 through G4 illustrated in FIGS. 8, 10, 11, 13, and 15. Note that, instead of carrying out step S501, the following steps S502 and S503 may be carried out successively after carrying out at least one of the information processing methods S10 through S40. In this case, the answer from each machine learning model is displayed with a summary without input of a summary creation instruction by the user.

In step S502, the summary generation section 113 generates a summary based on at least the first answer set. In a case where a first answer set through an m-th answer set (m is an integer of 2 or more) have been acquired, the summary generation section 113 generates a summary based on the first answer set through the m-th answer set. In step S503, the display control section 114 causes the display apparatus 150 to display the generated summary.

For example, the summary may be generated based on a keyword which is common between answers from the plurality of machine learning models ML in the first answer set (or in the first answer set through the m-th answer set). The keyword is not limited to one, but may be two or more keywords. The summary may include information that is not information related to the foregoing keyword and that is included in any of the plurality of machine learning models ML. The summary may be prepared in a form (e.g., table form, itemized form, or the like) in which answers from a plurality of machine learning models ML can be compared. Note that it is possible to use a known technique for generating a summary. For example, the summary generation section 113 may generate a summary by inputting the first answer set (or the first answer set through the m-th answer set) into a summary generative model (not illustrated) capable of generating a summary. Such a summary generative model may be, but not limited to, a language model.

The following description will discuss an example of a generated summary, with reference to FIG. 17. FIG. 17 is a diagram illustrating an example of a screen which includes a summary. In FIG. 17, a screen example G5 includes an example of a summary which is displayed when the summary button G15 is operated in the screen example G2 in the intervention function illustrated in FIG. 10. In the screen example G5, the summary is expressed in a table form which allows comparison of first answers and second answers between the company A, the company B, and the company C. Columns in this table correspond to the companies A, B, and C. The 1st and 2nd rows of the table are generated based on keywords “yen” (price) and “height” (size) which are common between first answers and second answers from the companies A, B, and C. The 3rd row of the table is generated with respect to “lie of hair” which is information other than information related to the keywords described above and is included in the second answer from the company C.

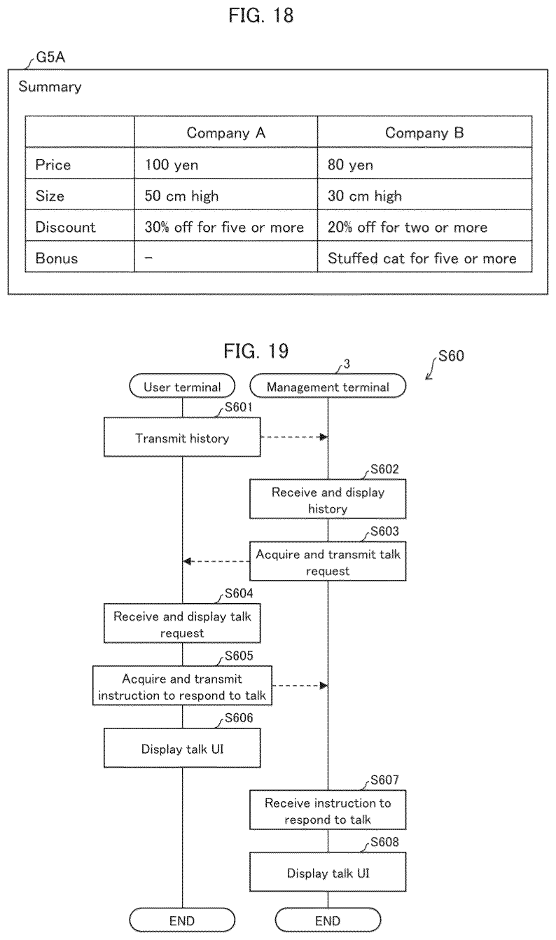

The following description will discuss another example of a generated summary, with reference to FIG. 18. FIG. 18 is a diagram illustrating another example of a screen which includes a summary. In FIG. 18, a screen example G5A includes an example of a summary which is displayed when the summary button G15 is operated in the screen example G4 in the debate function illustrated in FIG. 15. In the screen example G5A, the summary is expressed in a table form which allows comparison of first answers through third answers between the company A and the company B. Columns in this table correspond to the companies A and B. The 1st through 3rd rows of the table are generated based on keywords “yen” (price), “height” (size), and “discount” which are common between first answers through third answers from the companies A and B. The 4th row of the table is generated with respect to “bonus” which is information other than information related to the keywords described above and is included in the third answer from the company B.

As described above, the user terminal 10 employs a configuration which further includes the summary generation section 113 which generates a summary based on at least the first answer set, and in which the display control section 114 causes the display apparatus 150 to display the summary. Therefore, according to the user terminal 10, it is possible to bring about an example advantage of allowing the user to easily understand characteristics and differences in answers from the machine learning models ML, and as a result, the user can more easily carry out optimum selection for the user.

### (Talk Function: Flow of Information Processing Method S60)

Next, the following description will discuss a flow of an information processing method S60 which is carried out by the information processing system 1A, with reference to FIG. 19. FIG. 19 is a flowchart for describing the flow of the information processing method S60. The information processing method S60 realizes a talk function of the answer service which is provided by the information processing system 1A. As illustrated in FIG. 19, the information processing method S60 includes steps S601 through S608.

In step S601, the history transmission section 115 of the user terminal 10 transmits a history of information displayed on the display apparatus 150 to management terminals 30 via servers 20 which correspond to the respective plurality of machine learning models ML. In step S602, the history reception section 311 of the management terminal 30 receives the history and causes the display apparatus 350 to display the history.

The processes of steps S601 and S602 are repeated during the information processing methods S10 through S40 are carried out. For example, the processes of steps S601 and S602 may be carried out in response to updating of information displayed on the display apparatus 150 in the information processing methods S10 through S40. Thus, an operator who uses the management terminal 30 can confirm, in real time, exchange between the user of the user terminal 10 and each of the machine learning models ML.

In step S603, the talk UI section 312 of the management terminal 30 acquires an instruction to transmit a talk request, the instruction having been input by the operator. Upon acquisition of the instruction, the talk UI section 312 transmits the talk request to the user terminal 10 via the server 20. For example, a talk request transmission button may be disposed in a screen in which exchange is displayed in real time in the management terminal 30. In this case, the operator can instruct transmission of the talk request by operating the talk request transmission button.

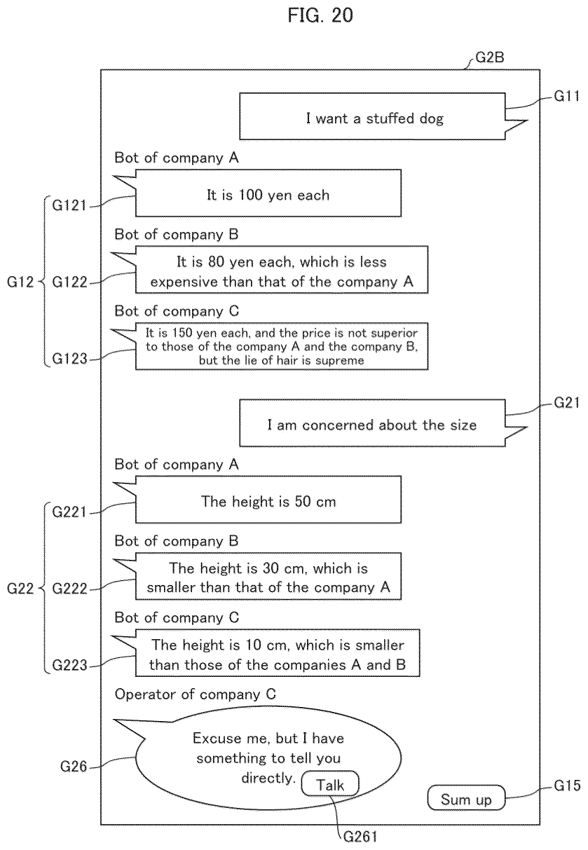

In step S604, upon receipt of the talk request, the talk UI section 116 of the user terminal 10 causes the display apparatus 150 to display information indicating the talk request. For example, the information indicating the talk request may include a button for instructing response to the talk request. The following description will discuss an example of a screen displayed on the display apparatus 150 in step S604, with reference to FIG. 20. A screen example illustrated in FIG. 20 includes a talk request G26 from an operator of the company C, in addition to a configuration similar to the screen example G2 illustrated in FIG. 10. For example, in a state where the screen example G2 is displayed, information equivalent to the screen example G2 is displayed on the display apparatus 350 of each of management terminals 30. Here, it is assumed that the operator of the company C has determined that a stuffed toy of the company C is disadvantageous as compared with the companies A and B in terms of price and size while browsing information equivalent to the screen example G2, and has instructed transmission of a talk request. The talk request G26 in the screen example G2B is displayed on the display apparatus 150 of the user terminal 10 in response to operation by the operator of the company C. Moreover, the operator of the company C can also make an instruction to transmit the talk request, for example, in a case where the operator has determined that the user is a loyal customer. The talk request G26 includes a button for responding to a talk request.

In step S605, the input acquisition section 111 of the user terminal 10 acquires an instruction to respond to a talk request, the instruction having been input by the user. For example, the user inputs an instruction to respond to the talk request by operating the talk button G261 included in the talk request G26 in the screen example G2B. Upon acquisition of the instruction, the talk UI section 116 transmits, via the server 20, information indicating an action to respond to the talk to the management terminal 30 which has transmitted the talk request.

In step S606, the talk UI section 116 of the user terminal 10 generates a user interface for carrying out a talk directly between the user and the operator. The display control section 114 causes the display apparatus 150 to display the user interface. The user interface can be implemented in a form in which the operator of the company C participates in the screen example G2B on which exchange between the user and the plurality of machine learning models ML is carried out. The user interface may be displayed on another screen different from the screen example G2B. In such a case, the user interface may be, for example, text chat or voice call.

In step S607, the talk UI section 312 of the management terminal 30 receives, from the user terminal 10, information indicating an action to respond to the talk request. In step S608, the talk UI section 312 generates a user interface for carrying out a talk directly between the user and the operator and causes the display apparatus 350 to display the generated user interface. Details of the user interface are as described in step S606, and therefore detailed descriptions thereof will not be repeated.

As described above, the user terminal 10 employs the configuration of further including: the history transmission section 115 that transmits a history of information displayed on the display apparatus 150 to a management terminal 30 corresponding to at least one of the plurality of machine learning models ML; and the talk UI section 116 that receives a talk request from the management terminal 30, the input acquisition section 111 acquiring an instruction to respond to a talk request which has been input by the user, and the display control section 114 causing, in response to the instruction, the display apparatus 150 to display a user interface for carrying out a talk between the user and an operator of the management terminal 30. Therefore, according to the user terminal 10, it is possible to bring about an example advantage that the user can obtain not only answers from the respective machine learning models ML but also information from the operator, which increases satisfaction. It is also possible to bring about an example advantage of allowing a management organization to be in a situation which is more advantageous to the management organization.

### Example Application

As described above, the example has been described in which the information processing system 1A provides an answer service which provides, as answers, information about a product, using a plurality of machine learning models ML which are managed, respectively, by companies that sell the product. Note, however, that organizations that manage a plurality of machine learning models ML are not limited to companies that sell products. For example, organizations that manage a plurality of machine learning models ML, respectively, may be hospitals. In this case, a user can collectively obtain, from a plurality of hospitals, answers in response to a request. Moreover, answers obtained in turn from the respective plurality of hospitals are answers obtained with reference to answers from the other hospitals which are earlier in the order than the hospital concerned. Thus, it is possible to efficiently obtain more useful information for comparing a plurality of hospitals, as compared with a case where answers from hospitals are simply obtained collectively. Specifically, the user can carry out, using the information processing system A, the following actions: (i) seek a second opinion; (ii) collectively reserve a plurality of hospitals; (iii) complete filling of a medical interview sheet in advance; and the like. In the action (i), the user can obtain an opinion from an arbitrary hospital with reference to opinions from other hospitals. In the action (ii), the user can make a reservation of an arbitrary hospital so that the reservation does not overlap with a reservation of another hospital which has been made earlier. In the action (iii), the user can include, in a medical interview sheet to be submitted to an arbitrary hospital, information which has been obtained from another hospital to which a medical interview sheet has been submitted earlier.

### (Variation of Apparatus Configuration)

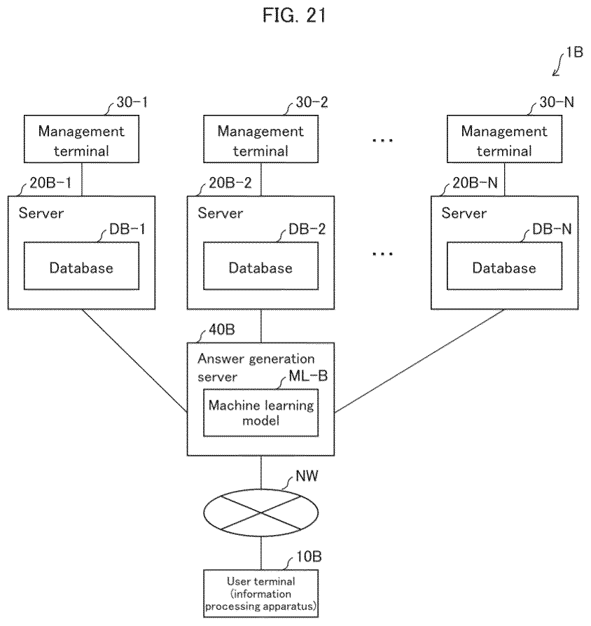

The apparatus configuration of the information processing system 1A illustrated in FIG. 3 can be altered as illustrated in FIGS. 21 through 23. FIGS. 21 through 23 are block diagrams each illustrating a variation of the apparatus configuration of the information processing system 1A.

In an information processing system 1B illustrated in FIG. 21, a general-purpose machine learning model ML-B behaves as a plurality of machine learning models ML by referring to a plurality of databases DB-i. The information processing system 1B includes a user terminal 10B, a plurality of servers 20B-i, a plurality of management terminals 30-i, and an answer generation server 40B. The management terminals 30-i can be described similarly to those in the information processing system 1A. Unlike the servers 20-i, each of the servers 20B-i includes a database DB-i instead of storing a machine learning model ML-i. The database DB-i stores information conforming to a management organization of the server 20-i. Moreover, unlike the servers 20-i, each of the servers 20B-i does not include a query reception section 211, an answer generation section 212, and an answer transmission section 213. These function blocks are stored in the answer generation server 40B. As the answer generation server 40B, a server which stores the general-purpose machine learning model ML-B can be applied. For example, the user terminal 10B is configured in the substantially same manner as the user terminal 10, but a query generated by the answer acquisition section 112 is slightly different. For example, the answer acquisition section 112 includes, as a query to be input into a k-th machine learning model ML, information “Please generate an answer with reference to the database DB-k” in addition to the foregoing query. Accordingly, the user terminal 10B can carry out processing while regarding the general-purpose machine learning model ML-B as a plurality of machine learning models ML. As a result, the information processing system 1B can provide an answer service similar to that of the information processing system 1A.

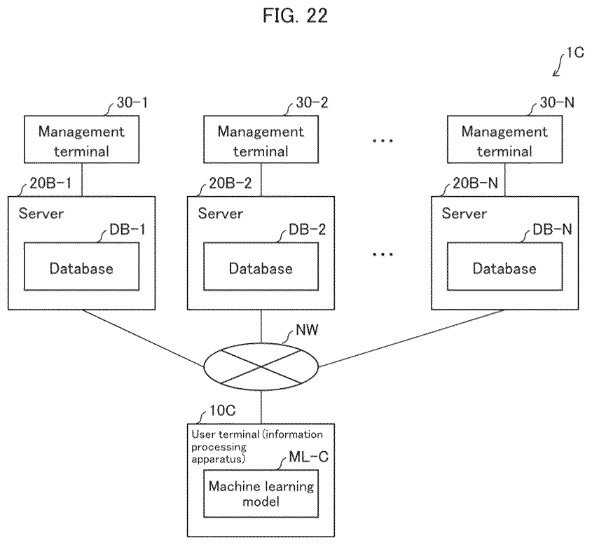

In an information processing system 1C illustrated in FIG. 22, a machine learning model ML-C which is stored in a user terminal 10C behaves as a plurality of machine learning models ML by referring to a plurality of databases DB-i. The information processing system 1C includes a user terminal 10C, a plurality of servers 20B-i, and a plurality of management terminals 30-i. The management terminals 30-i can be described similarly to those in the information processing system 1A. The servers 20B-i are as described above with reference to FIG. 21. The user terminal 10C is configured in the substantially same manner as the user terminal 10, except that the user terminal 10C stores the machine learning model ML-C. The machine learning model ML-C may be a general-purpose machine learning model. A query generated by the answer acquisition section 112 of the user terminal 10C is similar to a query generated by the answer acquisition section 112 of the user terminal 10B, and therefore detailed descriptions thereof will not be repeated. The answer acquisition section 112 of the user terminal 10C acquires an answer by inputting a query into the machine learning model ML-C which is stored in the user terminal 10C, instead of carrying out transmission and reception of a query and an answer with the server 20-i. Accordingly, the user terminal 10C can carry out processing while regarding the single machine learning model ML-C as a plurality of machine learning models ML. As a result, the information processing system 1C can provide an answer service similar to that of the information processing system 1A.

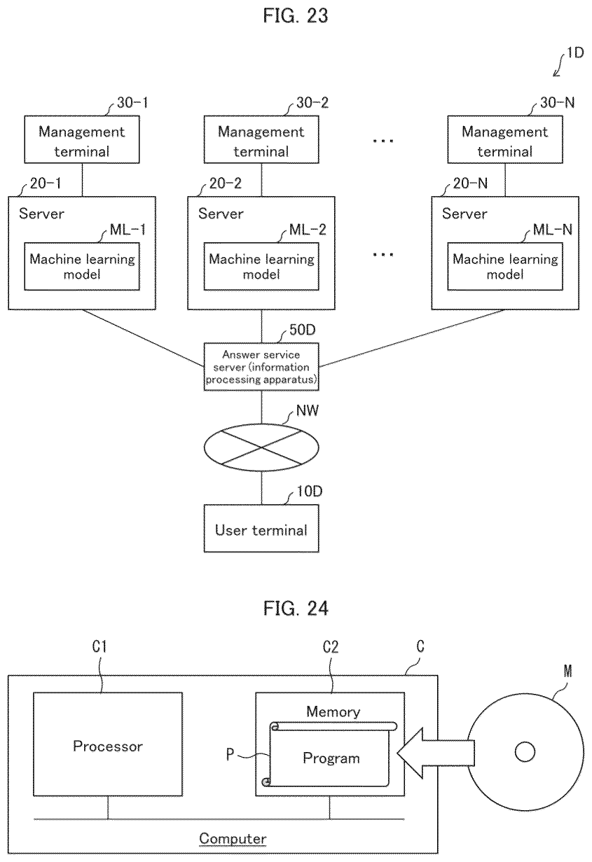

In an information processing system 1D illustrated in FIG. 23, an answer service server 50D realizes functions of the answer service and provides the functions to a user terminal 10D. The answer service server 50D is an example of the information processing apparatus. Here, the foregoing user terminals 10, 10B, and 10C are each implemented by a terminal in which a dedicated application for realizing the functions of the answer service is installed. In the information processing system D, it is not necessary that the dedicated application is installed in the user terminal 10D. The user can use the answer service by accessing the answer service server 50D using the user terminal 10D.

The information processing system 1D includes a user terminal 10D, a plurality of servers 20-i, a plurality of management terminals 30-i, and an answer service server 50D. The servers 20-i and the management terminals 30-i can be described similarly to those in the information processing system 1A. Unlike the user terminal 10, the user terminal 10D does not include an input acquisition section 111, an answer acquisition section 112, a summary generation section 113, a display control section 114, a history transmission section 115, and a talk UI section 116. These function blocks are included in the answer service server 50D. The user terminal 10D simply transmits an input from the input apparatus 140 to the answer service server 50D and causes the display apparatus 150 to display a screen received from the answer service server 50D. Thus, the information processing system 1D can provide an answer service similar to that of the information processing system 1A.

### [Software Implementation Example]

Some of or all of the functions of each of apparatuses (hereinafter referred to also as “each of the apparatuses”) constituting the information processing apparatus 1 and the information processing systems 1A, 1B, 1C, and 1D may be implemented by hardware such as an integrated circuit (IC chip), or may be implemented by software.

In the latter case, each of the apparatuses is implemented by, for example, a computer that executes instructions of a program that is software implementing the foregoing functions. FIG. 24 illustrates an example of such a computer (hereinafter, referred to as “computer C”). FIG. 24 is a block diagram illustrating a hardware configuration of the computer C which functions as each of the apparatuses.

The computer C includes at least one processor C1 and at least one memory C2. The memory C2 stores a program P for causing the computer C to operate as each of the apparatuses. The processor C1 of the computer C retrieves the program P from the memory C2 and executes the program P, so that the functions of each of the apparatuses are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium. [Additional remark A]

The present disclosure includes techniques described in supplementary notes below. Note, however, that the present invention is not limited to the techniques described in supplementary notes below, but may be altered in various ways by a skilled person within the scope of the claims.

### Supplementary Note A1

An information processing apparatus including: an input acquisition means for acquiring a first request from a user; an answer acquisition means for acquiring first answers respectively from a first machine learning model and a second machine learning model in response to the first request while causing the second machine learning model to refer to a first answer obtained from the first machine learning model; and a display control means for causing a display apparatus to display a first answer set which includes the first answers obtained respectively from the first machine learning model and the second machine learning model.

### Supplementary Note A2

The information processing apparatus according to supplementary note A1, in which: the answer acquisition means acquires, in response to the first request, first answers respectively from a plurality of machine learning models in turn which include the first machine learning model and the second machine learning model while causing each of 2nd and subsequent machine learning models to refer to a first answer obtained from each of machine learning models which has been used before that machine learning model.

### Supplementary Note A3

The information processing apparatus according to supplementary note A1 or A2, in which: the input acquisition means acquires a second request from the user in response to display of the first answer set; the answer acquisition means acquires second answers respectively from the first machine learning model and the second machine learning model in response to the second request while causing the second machine learning model to refer to a second answer obtained from the first machine learning model; and the display control means causes the display apparatus to display a second answer set which includes the second answers obtained respectively from the first machine learning model and the second machine learning model.

### Supplementary Note A4

The information processing apparatus according to any one of supplementary notes A1 through A3, in which: the input acquisition means acquires an instruction from the user to change an order of using the first machine learning model and the second machine learning model in response to display of the first answer set; the answer acquisition means acquires a new first answer from the first machine learning model in response to the first request while causing the first machine learning model to refer to a first answer obtained from the second machine learning model; and the display control means causes the display apparatus to display the new first answer obtained from the first machine learning model.

### Supplementary Note A5

The information processing apparatus according to any one of supplementary notes A1 through A4, in which: in a case where a first answer generable by the second machine learning model in response to the first request is disadvantageous as compared with the first answer obtained from the first machine learning model, the answer acquisition means controls the second machine learning model to refrain from generating the first answer generable by the second machine learning model.

### Supplementary Note A6

The information processing apparatus according to any one of supplementary notes A1 through A5, further including: a summary generation means for generating a summary based on at least the first answer set, the display control means causing the display apparatus to display the summary.

### Supplementary Note A7

The information processing apparatus according to any one of supplementary notes A1 through A6, in which: the answer acquisition means acquires, from the first machine learning model and the second machine learning model, respective second answers based on the first answer set while causing the second machine learning model to refer to a second answer obtained from the first machine learning model; and the display control means causes the display apparatus to display a second answer set which includes the second answers obtained respectively from the first machine learning model and the second machine learning model.

### Supplementary Note A8

The information processing apparatus according to any one of supplementary notes A1 through A7, further including: a history transmission means for transmitting a history of information displayed on the display apparatus to a management terminal which corresponds to at least one selected from the group consisting of the first machine learning model and the second machine learning model; and a talk request reception means for receiving a talk request from the management terminal, the input acquisition means acquiring an instruction from the user to respond to the request, and the display control means causing, in response to the instruction, the display apparatus to display a user interface for carrying out a talk between the user and an operator of the management terminal.

### Additional Remark B

The present disclosure includes techniques described in supplementary notes below. Note, however, that the present invention is not limited to the techniques described in supplementary notes below, but may be altered in various ways by a skilled person within the scope of the claims.

### Supplementary Note B1

An information processing method including: an input acquisition process of acquiring, by at least one processor, a first request from a user; an answer acquisition process of acquiring, by the at least one processor, first answers respectively from a first machine learning model and a second machine learning model in response to the first request while causing the second machine learning model to refer to a first answer obtained from the first machine learning model; and a display control process of causing, by the at least one processor, a display apparatus to display a first answer set which includes the first answers obtained respectively from the first machine learning model and the second machine learning model.

### Supplementary Note B2

The information processing method according to supplementary note B1, in which: in the answer acquisition process, the at least one processor acquires, in response to the first request, first answers respectively from a plurality of machine learning models in turn which include the first machine learning model and the second machine learning model while causing each of 2nd and subsequent machine learning models to refer to a first answer obtained from each of machine learning models which has been used before that machine learning model.

### Supplementary Note B3

The information processing method according to supplementary note B1 or B2, in which: in the input acquisition process, the at least one processor acquires a second request from the user in response to display of the first answer set; in the answer acquisition process, the at least one processor acquires second answers respectively from the first machine learning model and the second machine learning model in response to the second request while causing the second machine learning model to refer to a second answer obtained from the first machine learning model; and in the display control process, the at least one processor causes the display apparatus to display a second answer set which includes the second answers obtained respectively from the first machine learning model and the second machine learning model.

### Supplementary Note B4

The information processing method according to any one of supplementary notes B1 through B3, in which: in the input acquisition process, the at least one processor acquires an instruction from the user to change an order of using the first machine learning model and the second machine learning model in response to display of the first answer set; in the answer acquisition process, the at least one processor acquires a new first answer from the first machine learning model in response to the first request while causing the first machine learning model to refer to a first answer obtained from the second machine learning model; and in the display control process, the at least one processor causes the display apparatus to display the new first answer obtained from the first machine learning model.

### Supplementary Note B5

The information processing method according to any one of supplementary notes B1 through B4, in which: in a case where a first answer generable by the second machine learning model in response to the first request is disadvantageous as compared with the first answer obtained from the first machine learning model, the answer acquisition process controls the second machine learning model to refrain from generating the first answer generable by the second machine learning model.

### Supplementary Note B6

The information processing method according to any one of supplementary notes B1 through B5, further including: a summary generation process of generating, by the at least one processor, a summary based on at least the first answer set, in the display control process, the at least one processor causing the display apparatus to display the summary.

### Supplementary Note B7

The information processing method according to any one of supplementary notes B1 through B6, in which: in the answer acquisition process, the at least one processor acquires, from the first machine learning model and the second machine learning model, respective second answers based on the first answer set while causing the second machine learning model to refer to a second answer obtained from the first machine learning model; and in the display control process, the at least one processor causes the display apparatus to display a second answer set which includes the second answers obtained respectively from the first machine learning model and the second machine learning model.

### Supplementary Note B8

The information processing method according to any one of supplementary notes B1 through B7, further including: a history transmission process of transmitting, by the at least one processor, a history of information displayed on the display apparatus to a management terminal which corresponds to at least one selected from the group consisting of the first machine learning model and the second machine learning model; and a talk request reception process of receiving, by the at least one processor, a talk request from the management terminal, in the input acquisition process, the at least one processor acquiring an instruction from the user to respond to the talk request; and in the display control process, the at least one processor causing, in response to the instruction, the display apparatus to display a user interface for carrying out a talk between the user and an operator of the management terminal.

### Additional Remark C

The present disclosure includes techniques described in supplementary notes below. Note, however, that the present invention is not limited to the techniques described in supplementary notes below, but may be altered in various ways by a skilled person within the scope of the claims.

### Supplementary Note C1

An information processing program for causing a computer to function as an information processing apparatus, the program causing the computer to function as: an input acquisition means for acquiring a first request from a user; an answer acquisition means for acquiring first answers respectively from a first machine learning model and a second machine learning model in response to the first request while causing the second machine learning model to refer to a first answer obtained from the first machine learning model; and a display control means for causing a display apparatus to display a first answer set which includes the first answers obtained respectively from the first machine learning model and the second machine learning model.

### Supplementary Note C2

The information processing program according to supplementary note C1, in which: the answer acquisition means acquires, in response to the first request, first answers respectively from a plurality of machine learning models in turn which include the first machine learning model and the second machine learning model while causing each of 2nd and subsequent machine learning models to refer to a first answer obtained from each of machine learning models which has been used before that machine learning model.

### Supplementary Note C3

The information processing program according to supplementary note C1 or C2, in which: the input acquisition means acquires a second request from the user in response to display of the first answer set; the answer acquisition means acquires second answers respectively from the first machine learning model and the second machine learning model in response to the second request while causing the second machine learning model to refer to a second answer obtained from the first machine learning model; and the display control means causes the display apparatus to display a second answer set which includes the second answers obtained respectively from the first machine learning model and the second machine learning model.

### Supplementary Note C4

The information processing program according to any one of supplementary notes C1 through C3, in which: the input acquisition means acquires an instruction from the user to change an order of using the first machine learning model and the second machine learning model in response to display of the first answer set; the answer acquisition means acquires a new first answer from the first machine learning model in response to the first request while causing the first machine learning model to refer to a first answer obtained from the second machine learning model; and the display control means causes the display apparatus to display the new first answer obtained from the first machine learning model.

### Supplementary Note C5

The information processing program according to any one of supplementary notes C1 through C4, in which: in a case where a first answer generable by the second machine learning model in response to the first request is disadvantageous as compared with the first answer obtained from the first machine learning model, the answer acquisition means controls the second machine learning model to refrain from generating the first answer generable by the second machine learning model.

### Supplementary Note C6

The information processing program according to any one of supplementary notes C1 through C5, which causes the computer to further function as: a summary generation means for generating a summary based on at least the first answer set, the display control means causing the display apparatus to display the summary.

### Supplementary Note C7

The information processing program according to any one of supplementary notes C1 through C6, in which: the answer acquisition means acquires, from the first machine learning model and the second machine learning model, respective second answers based on the first answer set while causing the second machine learning model to refer to a second answer obtained from the first machine learning model; and the display control means causes the display apparatus to display a second answer set which includes the second answers obtained respectively from the first machine learning model and the second machine learning model.

### Supplementary Note C8

The information processing program according to any one of supplementary notes C1 through C7, which causes the computer to further function as: a history transmission means for transmitting a history of information displayed on the display apparatus to a management terminal which corresponds to at least one selected from the group consisting of the first machine learning model and the second machine learning model; and a talk request reception means for receiving a talk request from the management terminal, the input acquisition means acquiring an instruction from the user to respond to the talk request; and the display control means causing, in response to the instruction, the display apparatus to display a user interface for carrying out a talk between the user and an operator of the management terminal.

### Additional Remark D

The present disclosure includes techniques described in supplementary notes below. Note, however, that the present invention is not limited to the techniques described in supplementary notes below, but may be altered in various ways by a skilled person within the scope of the claims.

### Supplementary Note D1

An information processing apparatus including at least one processor, the at least one processor carrying out: an input acquisition process of acquiring a first request from a user; an answer acquisition process of acquiring first answers respectively from a first machine learning model and a second machine learning model in response to the first request while causing the second machine learning model to refer to a first answer obtained from the first machine learning model; and a display control process of causing a display apparatus to display a first answer set which includes the first answers obtained respectively from the first machine learning model and the second machine learning model.

Note that the information processing apparatus can further include a memory. In the memory, a program for causing the at least one processor to carry out the processes can be stored.

### Supplementary Note D2

The information processing apparatus according to supplementary note D1, in which: in the answer acquisition process, the at least one processor acquires, in response to the first request, first answers respectively from a plurality of machine learning models in turn which include the first machine learning model and the second machine learning model while causing each of 2nd and subsequent machine learning models to refer to a first answer obtained from each of machine learning models which has been used before that machine learning model.

### Supplementary Note D3

The information processing apparatus according to supplementary note D1 or D2, in which: in the input acquisition process, the at least one processor acquires a second request from the user in response to display of the first answer set; in the answer acquisition process, the at least one processor acquires second answers respectively from the first machine learning model and the second machine learning model in response to the second request while causing the second machine learning model to refer to a second answer obtained from the first machine learning model; and in the display control process, the at least one processor causes the display apparatus to display a second answer set which includes the second answers obtained respectively from the first machine learning model and the second machine learning model.

### Supplementary Note D4

The information processing apparatus according to any one of supplementary notes D1 through D3, in which: in the input acquisition process, the at least one processor acquires an instruction from the user to change an order of using the first machine learning model and the second machine learning model in response to display of the first answer set; in the answer acquisition process, the at least one processor acquires a new first answer from the first machine learning model in response to the first request while causing the first machine learning model to refer to a first answer obtained from the second machine learning model; and in the display control process, the at least one processor causes the display apparatus to display the new first answer obtained from the first machine learning model.

### Supplementary Note D5

The information processing apparatus according to any one of supplementary notes D1 through D4, in which: in a case where a first answer generable by the second machine learning model in response to the first request is disadvantageous as compared with the first answer obtained from the first machine learning model, the answer acquisition process controls the second machine learning model to refrain from generating the first answer generable by the second machine learning model.

### Supplementary Note D6

The information processing apparatus according to any one of supplementary notes D1 through D5, in which: the at least one processor further carries out a summary generation process of generating a summary based on at least the first answer set; and in the display control process, the at least one processor causes the display apparatus to display the summary.

### Supplementary Note D7

The information processing apparatus according to any one of supplementary notes D1 through D6, in which: in the answer acquisition process, the at least one processor acquires, from the first machine learning model and the second machine learning model, respective second answers based on the first answer set while causing the second machine learning model to refer to a second answer obtained from the first machine learning model; and in the display control process, the at least one processor causes the display apparatus to display a second answer set which includes the second answers obtained respectively from the first machine learning model and the second machine learning model.

### Supplementary Note D8

The information processing apparatus according to any one of supplementary notes D1 through D7, in which: the at least one processor further carries out a history transmission process of transmitting a history of information displayed on the display apparatus to a management terminal which corresponds to at least one selected from the group consisting of the first machine learning model and the second machine learning model; and the at least one processor further carries out a talk request reception process of receiving a talk request from the management terminal; in the input acquisition process, the at least one processor acquires an instruction from the user to respond to the talk request; and in the display control process, the at least one processor causes, in response to the instruction, the display apparatus to display a user interface for carrying out a talk between the user and an operator of the management terminal.

### Additional Remark E

The present disclosure includes techniques described in supplementary notes below. Note, however, that the present invention is not limited to the techniques described in supplementary notes below, but may be altered in various ways by a skilled person within the scope of the claims.

### Supplementary Note E1

A non-transitory storage medium storing an information processing program for causing a computer to function as an information processing apparatus, the information processing program causing the computer to carry out: an input acquisition process of acquiring a first request from a user; an answer acquisition process of acquiring first answers respectively from a first machine learning model and a second machine learning model in response to the first request while causing the second machine learning model to refer to a first answer obtained from the first machine learning model; and a display control process of causing a display apparatus to display a first answer set which includes the first answers obtained respectively from the first machine learning model and the second machine learning model.

### REFERENCE SIGNS LIST

1: Information processing apparatus
1A, 1B, 1C, 1D: Information processing system
10, 10B, 10C, 10D: User terminal
20, 20B: Server
30: Management terminal
40B: Answer generation server
50D: Answer service server
110, 210, 310: Control section
120, 220, 320: Storage section
130, 230, 330: Communication section
140, 340: Input apparatus
150, 350: Display apparatus
11, 111: Input acquisition section
12, 112: Answer acquisition section
13, 114: Display control section
113: Summary generation section
115: History transmission section
116, 312: Talk UI section
211: Query reception section
212: Answer generation section
213: Answer transmission section
311: History reception section
C1: Processor
C2: Memory

1. An information processing apparatus comprising at least one processor, the at least one processor carrying out:
an input acquisition process of acquiring a first request from a user;
an answer acquisition process of acquiring first answers respectively from a first machine learning model and a second machine learning model in response to the first request while causing the second machine learning model to refer to a first answer obtained from the first machine learning model; and
a display control process of causing a display apparatus to display a first answer set which includes the first answers obtained respectively from the first machine learning model and the second machine learning model.

2. The information processing apparatus according to claim 1, wherein:
in the answer acquisition process, the at least one processor acquires, in response to the first request, first answers respectively from a plurality of machine learning models in turn which include the first machine learning model and the second machine learning model while causing each of 2nd and subsequent machine learning models to refer to a first answer obtained from each of machine learning models which has been used before that machine learning model.

3. The information processing apparatus according to claim 1, wherein:
in the input acquisition process, the at least one processor acquires a second request from the user in response to display of the first answer set;
in the answer acquisition process, the at least one processor acquires second answers respectively from the first machine learning model and the second machine learning model in response to the second request while causing the second machine learning model to refer to a second answer obtained from the first machine learning model; and
in the display control process, the at least one processor causes the display apparatus to display a second answer set which includes the second answers obtained respectively from the first machine learning model and the second machine learning model.

4. The information processing apparatus according to claim 1, wherein:
in the input acquisition process, the at least one processor acquires an instruction from the user to change an order of using the first machine learning model and the second machine learning model in response to display of the first answer set;
in the answer acquisition process, the at least one processor acquires a new first answer from the first machine learning model in response to the first request while causing the first machine learning model to refer to a first answer obtained from the second machine learning model; and
in the display control process, the at least one processor causes the display apparatus to display the new first answer obtained from the first machine learning model.

5. The information processing apparatus according to claim 1, wherein:
in a case where a first answer generable by the second machine learning model in response to the first request is disadvantageous as compared with the first answer obtained from the first machine learning model, the at least one processor controls, in the answer acquisition process, the second machine learning model to refrain from generating the first answer generable by the second machine learning model.

6. The information processing apparatus according to claim 1, wherein:
the at least one processor further carries out a summary generation process of generating a summary based on at least the first answer set; and
in the display control process, the at least one processor causes the display apparatus to display the summary.

7. The information processing apparatus according to claim 1, wherein:
in the answer acquisition process, the at least one processor acquires, from the first machine learning model and the second machine learning model, respective second answers based on the first answer set while causing the second machine learning model to refer to a second answer obtained from the first machine learning model; and
in the display control process, the at least one processor causes the display apparatus to display a second answer set which includes the second answers obtained respectively from the first machine learning model and the second machine learning model.

8. The information processing apparatus according to claim 1, wherein:
the at least one processor further carries out a history transmission process of transmitting a history of information displayed on the display apparatus to a management terminal which corresponds to at least one selected from the group consisting of the first machine learning model and the second machine learning model; and
the at least one processor further carries out a talk request reception process of receiving a talk request from the management terminal;
in the input acquisition process, the at least one processor acquires an instruction from the user to respond to the talk request; and
in the display control process, the at least one processor causes, in response to the instruction, the display apparatus to display a user interface for carrying out a talk between the user and an operator of the management terminal.

9. An information processing method comprising:
acquiring, by at least one processor, a first request from a user;
acquiring, by the at least one processor, first answers respectively from a first machine learning model and a second machine learning model in response to the first request while causing the second machine learning model to refer to a first answer obtained from the first machine learning model; and
causing, by the at least one processor, a display apparatus to display a first answer set which includes the first answers obtained respectively from the first machine learning model and the second machine learning model.

10. A non-transitory storage medium storing a program for causing a computer to function as an information processing apparatus, the program causing the computer to carry out:
an input acquisition process of acquiring a first request from a user;
an answer acquisition process of acquiring first answers respectively from a first machine learning model and a second machine learning model in response to the first request while causing the second machine learning model to refer to a first answer obtained from the first machine learning model; and
a display control process of causing a display apparatus to display a first answer set which includes the first answers obtained respectively from the first machine learning model and the second machine learning model.
